(19) United States
(12) Patent Application Publication
(10) Pub. No.: US 2005/0012833 A1
(43) Pub. Date: Jan. 20, 2005

(54) Image capturing apparatus

(76) Inventors: Satoshi Yokota, Toyonaka-Shi (JP); Kenji Nakamura, Sakai-Shi (JP); Akira Shiraishi, Sakai-Shi (JP); Kazumi Kageyama, Sakai-Shi (JP)

Correspondence Address: SIDLEY AUSTIN BROWN & WOOD LLP, 717 NORTH HARWOOD, SUITE 3400, DALLAS, TX, 75201, US

(21) Appl. No.: 10/703,229

(22) Filed: Nov. 6, 2003

(30) Foreign Application Priority Data
Jul. 14, 2003 (JP) P2003-196248

(51) Int. Cl. H04N 5/262

(52) U.S. Cl. 348/240.99

(57) ABSTRACT

The present invention provides an image capturing apparatus capable of properly zooming in on a main subject without performing complicated framing. A digital camera having an electronic zoom function has an external passive type distance detector for obtaining two-dimensional distance detection information. The two-dimensional distance detection information obtained by the distance detector is used for an auto-focus control of the digital camera. Further, the two-dimensional distance detection information is also used for detection of a main subject in an image capturing area. The digital camera specifies the position of the main subject by using the two-dimensional distance detection information and moves the center of the partial area to be extracted in the case of generating a pseudo zoom image toward the specified position.

This application is based on application No. 2003-196248 filed in Japan, the contents of which are hereby incorporated by reference.

### BACKGROUND OF THE INVENTION

1. Field of the Invention

The present invention relates to an image capturing apparatus having an electronic zoom function.

2. Description of the Background Art

With development of the electronic technology in recent years, a digital camera for capturing a light image of a subject and generating digital image data is used in a wider range. The digital image data has a feature such that a pseudo zoom image is easily generated (trimmed) by extracting a partial area in an image. Some digital cameras have an electron zoom function utilizing the feature of the digital image data. For example, the electronic zoom function is provided, as means for enabling a single-focal length digital camera which does not have an optical zoom function to perform pseudo zoom operation, for the single-focal length digital camera. Alternately, the electronic zoom function is provided as means for falsely increasing the zoom magnification at the time of zoom operation also for a digital camera having an optical zoom function.

In a digital camera having such an electronic zoom function, a focus adjustment area is often changed in accordance with the size of a partial area which is extracted by the electronic zoom. Further, a digital camera in which a position of focus adjustment area on a subject is kept constant at the time of an electronic zoom is also known. However, in the above digital cameras, the center of an image during zooming is set so as to coincide with the center of an original image.

In the techniques in which the center of an image is fixed during zooming, there is a problem such that a main subject near the center of the angle of view in a wide-angle image comes to the peripheral portion of the angle of view in a telephoto image. There is a problem such that, in order to capture the main subject in the center of the angle of view in a telephoto image, the user has to perform framing again on the main subject as the user zooms in on the main subject. The re-framing tends to cause a camera shake at the time of zooming in, so that it becomes an issue particularly in photographing of a movie image.

On the other hand, a technique of changing the center of an image at the time of zooming is also known. For example, there is provided a plurality of auto-focus frames in an image and the enter of an image is switched among the centers of the auto-focus frames at the time of zooming.

In the technique, a method of moving the center of a telephoto image has to be preset, so that a main subject of which motion is not easily expected cannot be photographed properly. A problem occurs such that when the main subject moves unexpectedly, photographing fails.

### SUMMARY OF THE INVENTION

The present invention is directed to an image capturing apparatus.

According to a first aspect of the present invention, an image capturing apparatus includes: an optical system for forming a light image of a subject; an image sensor for converting the light image to image data; a main object detector for determining the position of a main object in the light image; and a zoom controller for generating a pseudo zoom image by extracting a partial area in the image, wherein when a zoom is performed in the direction of increasing an electronic zoom magnification, the zoom controller performs an electronic zoom of increasing the electronic zoom magnification while moving the position of the partial area toward the main object position.

According to the image capturing apparatus, since the position of the partial area is determined on the basis of the position of a main object, a main subject which is not existing in the center of an image can be automatically captured in the center of a pseudo telephoto image. Consequently, framing operation at the time of an electronic zoom becomes unnecessary.

According to a second aspect of the present invention, an image capturing apparatus includes: an optical system for forming a light image of a subject; an image sensor for converting the light image to image data; a main object detector for determining the position of a main object in the light image; and a zoom controller for generating a pseudo zoom image by extracting a partial area in the image, wherein when a zoom is performed in the direction of increasing an electronic zoom magnification, the zoom controller performs an electronic zoom of increasing the electronic zoom magnification while moving the position of the partial area toward a target position determined on the basis of movement of the position of the main subject determined by detection of the position of the main subject at a plurality of time points.

According to the image capturing apparatus, the position of the partial area is determined on the basis of the position of the main subject at a plurality of time points, so that the moving main subject can be automatically captured in the center of a pseudo telephoto image. Thus, the framing operation at the time of an electronic zoom becomes unnecessary.

According to a third aspect of the present invention, an image capturing apparatus includes: an optical system for forming a light image of a subject; an image sensor for converting the light image to image data; a main object detector for determining the position of a main object in the light image; a zoom controller for generating a pseudo zoom image by extracting a partial area in the image; and a movement detector for detecting whether the main object is moving or not on the basis of the positions of the main object determined at a plurality of time points, wherein when a zoom is performed in the direction of increasing an electronic zoom magnification, in a case where the movement detector detects that the main object is not moving, the zoom controller performs an electronic zoom while moving the position of the partial area toward the main object position, and in a case where it is determined that the main object is moving, the zoom controller performs an electronic zoom while moving the position of the partial area toward the target position determined on the basis of the detected movement of the main subject position.

According to the image capturing apparatus, the zoom process is changed according to whether the main subject is moving or stationary, so that the zoom process suitable to the state of the main subject can be automatically performed.

These and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a flowchart of a schematic operation of capturing a still image;

FIG. 2 is a flowchart of a schematic operation of capturing a movie image;

FIG. 3 is a front view illustrating the hardware configuration of a digital camera 1A;

FIG. 4 is a sectional view illustrating the hardware configuration of the digital camera 1A;

FIG. 5 is a rear view illustrating the hardware configuration of the digital camera 1A;

FIG. 6 is a block diagram showing the functional configuration of the digital camera 1A;

FIG. 7 is a sectional view of a passive AF module 130;

FIG. 8 is a front view of a sensor chip 131 of the passive AF module 130;

FIG. 9 is a diagram showing the relation between an image capturing area CA and a distance detection area FA at a wide angle end;

FIG. 10 is a diagram showing the relation between the image capturing area CA and the distance detection area FA at a telephoto end;

FIG. 11 is a block diagram showing the configuration of a main subject position specifying unit 254;

FIG. 12 is a diagram showing a distance detection image FI as a line drawing;

FIG. 13 is a diagram showing a distance detection image LI generated by a distance image generating unit 254a;

FIG. 14 is a diagram showing a state where the distance detection image FI is divided;

FIG. 15 is a diagram showing the relation between a block L (i, j) and a block P (x, y);

FIG. 16 is a diagram showing the relation between the block L (i, j) and the block P (x, y);

FIG. 17 is a diagram showing the relation between the block L (i, j) and the block P (x, y);

FIG. 18 is a diagram schematically showing the image capturing area CA including a main subject SB;

FIG. 19 is a diagram schematically showing the image capturing area CA including the main subject SB;

FIG. 20 is a diagram schematically showing a captured image CI by a line drawing;

FIG. 21 is a diagram schematically showing the captured image CI by a line drawing;

FIG. 22 is a flowchart of an operation flow of a fixed electronic zoom process;

FIG. 23 is a diagram schematically showing the captured image CI by a line drawing;

FIG. 24 is a diagram schematically showing the captured image CI by a line drawing;

FIG. 25 is a flowchart of an operation flow of a stationary subject electronic zoom process;

FIG. 26 is a flowchart for describing the whole zooming operation;

FIG. 27 is a diagram schematically showing a state where a frame FR is superimposed on a captured image CI;

FIG. 28 is a diagram showing a state where a partial area PA approaches the frame FR;

FIG. 29 is a diagram schematically showing a state where the capturing area CA and the distance detection area FA almost coincide with each other;

FIG. 30 is a diagram showing that the capturing area CA can be used to its ends as the partial area PA;

FIG. 31 is a diagram schematically showing a captured image CI including a plurality of main subjects SB1 to SB3 as a line drawing;

FIG. 32 is a diagram schematically showing the captured image CI including the plurality of main subjects SB1 to SB3 as a line drawing;

FIG. 33 is a diagram schematically showing the image capturing area CA including a main subject SB;

FIG. 34 is a diagram schematically showing the image capturing area CA including the main subject SB;

FIG. 35 is a diagram schematically showing the captured image CI as a line drawing;

FIG. 36 is a diagram schematically showing the captured image CI as a line drawing;

FIG. 37 is a diagram schematically showing the captured image CI as a line drawing;

FIG. 38 is a flowchart of the operation flow of a moving subject electronic zoom process;

FIG. 39 is a flowchart for describing the whole moving subject electronic zoom process; and

FIG. 40 is a flowchart for describing the whole moving subject electronic zoom process.

### DESCRIPTION OF THE PREFERRED EMBODIMENTS

First Preferred Embodiment

A digital camera 1A of a first preferred embodiment has an electronic zoom function. The electronic zoom function is also referred to as a digital zoom function, a pseudo zoom function, or a pseudo 2-focal-length changeover function. The electronic zoom function is a function of reducing an image data capturing range from an optical image formed by an optical system while maintaining the focal length constant. By the electronic zoom function, a visual effect that the focal length becomes longer can be falsely obtained.

The digital camera 1A has an external passive type distance detector for obtaining two-dimensional distance detection information. Two-dimensional distance detection information obtained by the distance detector is used for an auto-focus (AF) control of the digital camera 1A. Further, the two-dimensional distance detection information is used for detecting a main subject such as a person. The digital camera 1A specifies the position of the main subject in a captured image by using the two-dimensional distance image and automatically generates a zooming image obtained by moving the center to the position of the main subject from the captured image. In the following, the electronic zoom will be referred to as automatic trimming electronic zoom.

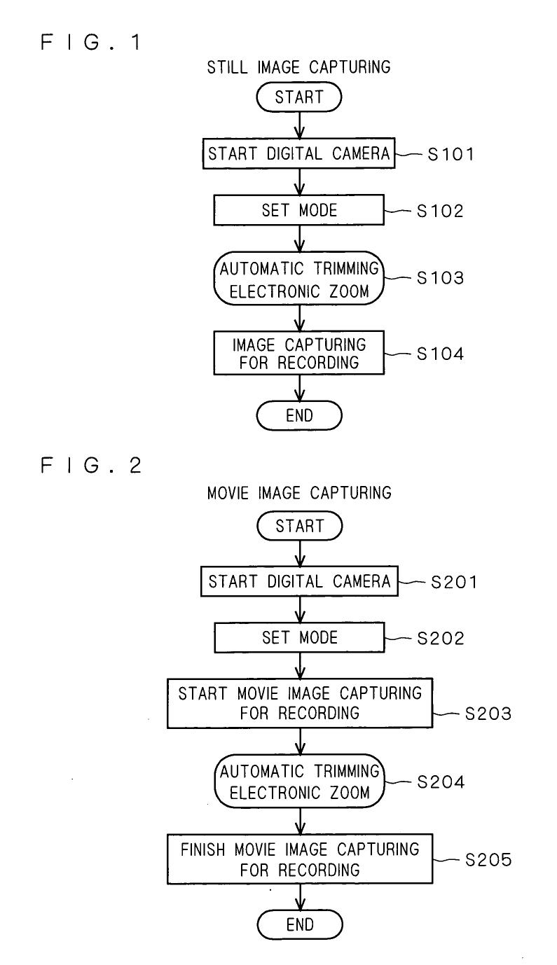

The digital camera 1A can capture both a still image and a movie image. In the case of a still image, the digital camera 1A can perform the automatic trimming electronic zoom prior to photographing. On the other hand, in the case of a movie image, the digital camera 1A can perform the automatic trimming electronic zooming during photographing. The schematic photographing operation of the digital camera 1A will be briefly described with reference to the flowcharts of FIGS. 1 and 2.

FIG. 1 is a flowchart showing a schematic operation of capturing a still image. In the case of capturing a still image, the digital camera 1A is started in step S101. In step S102, the image capturing mode of the digital camera 1A is set to a still image capturing mode. In step S103 subsequent to step S102, in response to operation of the user, automatic trimming electronic zoom is executed in the digital camera 1A. After completion of the automatic trimming electronic zoom, in step S104, image capturing is performed, and the flow of the still image capturing operation is finished.

FIG. 2 is a flowchart showing a schematic operation of capturing a movie image. In the case of capturing a movie image, the digital camera 1A is started in step S201. In step S202, the image capturing mode of the digital camera 1A is set to a movie image capturing mode. In step S203, in response to an operation of the user, movie image capturing operation in the digital camera 1A is started. In step S204 subsequent to step S203, in response to an operation of the user, automatic trimming electronic zoom is executed in the digital camera 1A. In step S205, the movie image capturing operation in the digital camera 1A is finished in response to an operation of the user, and the flow of the movie image capturing operation is finished.

A concrete configuration of the digital camera 1A and the operation of the automatic trimming electronic zoom will be specifically described in order.

Hardware Configuration

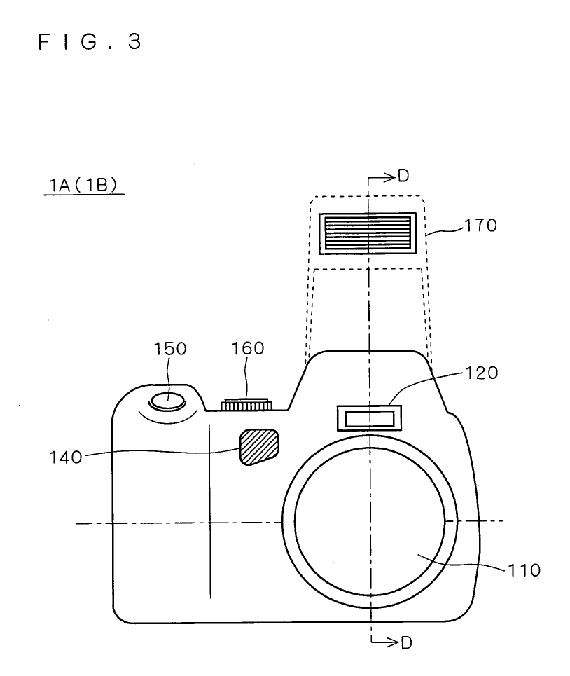

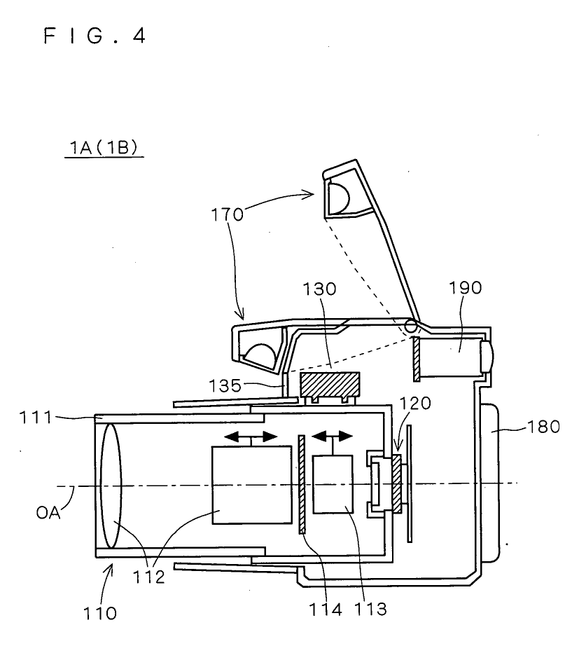

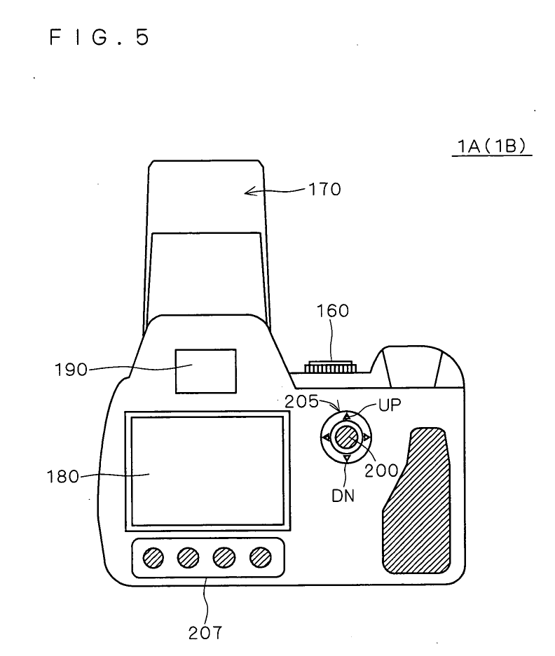

The hardware configuration of the digital camera 1A will be described with reference to FIGS. 3 to 5. FIG. 3 is a front view of the digital camera 1A. FIG. 4 is a sectional view of the digital camera 1A taken along line D-D of FIG. 2. FIG. 5 is a rear view of the digital camera 1A.

On the front face of the digital camera 1A, a taking lens 110 is provided. The taking lens 110 forms an optical image (optical image of a subject) and allows the image to be formed on the light reception surface of a CCD (Charge Coupled Device) 120 as an image sensor. In a lens barrel 111 of the taking lens 110, a zoom lens group 112 for changing the angle of view of the optical image and a focus lens group 113 for changing a focus state of the optical image are provided. The zoom lens group 112 and the focus lens group 113 are connected to a not-shown encoder. With the configuration, the digital camera 1A can detect the positions in the direction of an optical axis OA of the zoom lens group 112 and focus lens group 113. The zoom lens group 112 and focus lens group 113 are connected to a not-shown zoom motor and a not-shown focus motor, respectively. Consequently, the digital camera 1A can drive the zoom lens group 112 and the focus lens group 113 in the optical axis OA direction. The digital camera 1A is constructed so as to be able to perform optical zoom and focus control by the driving of the optical system. The taking lens 110 has an aperture 114 for changing an amount of light entering the CCD 120. The aperture stop mechanism (referred to as “aperture”) 114 is provided between the zoom lens group 112 and the focus lens group 113. The aperture 114 is connected to a not-shown aperture motor. With the configuration, the digital camera 1A can change the aperture diameter for exposure control.

A distance detection window 135 for obtaining an optical image for distance detection is provided above the taking lens 110 of the digital camera 1A in the front face. The optical image for distance detection obtained through the distance detection window 135 is incident on a passive AF module 130 provided in the digital camera 1A. The passive AF module 130 detects the distance in the direction almost perpendicular to the light reception face of the CCD 120 in a two-dimensional distance detection area almost parallel to the light reception face of the CCD 120.

Further, in the front face of the digital camera 1A, an AF illuminator 140 for illuminating the subject with AF assist light is provided. The AF illuminator 140 uses a light emission diode as a light source. The AF illuminator 140 automatically emits light and illuminates the subject with AF assist light at the time of low luminance and at the time of low contrast.

On the top face of the digital camera 1A, a shutter start button 150 (hereinafter, simply referred to as shutter button) for giving an instruction to start photographing to the digital camera 1A, a mode setting dial 160 for setting an operation mode of the digital camera 1A, and a pop-up flash 170 which emits light at the time of photographing with flash light are provided.

The shutter button 150 is a push button switch capable of detecting a part way pressed state (hereinafter, referred to as “S1 state”) and an all the way pressed state (hereinafter, referred to as “S2 state”). When the digital camera 1A detects that the shutter button 150 enters the S1 state, the digital camera 1A starts an image recording preparing operation such as AF control. When the digital camera 1A detects that the shutter button 150 enters the S2 state, the digital camera 1A starts the image capturing operation for recording.

The mode setting dial 160 is a rotary switch for switching the operation mode of the digital camera 1A among a “still image recording mode” for capturing a still image of a subject, a “movie image recording mode” for capturing a movie image of a subject, and a “playback mode” playing back a stored image.

On the rear face of the digital camera 1A, a liquid crystal display (LCD) 180 for performing live view display of a captured image and playing back a recorded image is provided. On the rear face, an electronic view finder (EVF) 190 for displaying a live view of the captured image is provided above the LCD 180. A cross switch 205 for performing zooming at the time of image capturing, feeding frames at the time of image playback, and the like is provided on the rear face. The cross switch 205 has four up, down, left and right push buttons UP, DN, LF and RT. When the up button UP is depressed, zooming to a telephoto side shot is performed. When the down push button DN is depressed, zooming to a wide-angle side is performed.

Further, in the center of the cross switch 205 in the rear face of the digital camera 1A, an automatic trimming button 200 for instructing the digital camera 1A to zoom in on a main subject detected is provided. When depression of the automatic trimming button 200 is detected, the digital camera 1A starts an automatic zoom-in operation on the detected main subject. At the time of zoom-in by the automatic trimming button 200, a zoom in area can be changed so that the main subject is captured in the center portion of the angle of view.

Functional Configuration

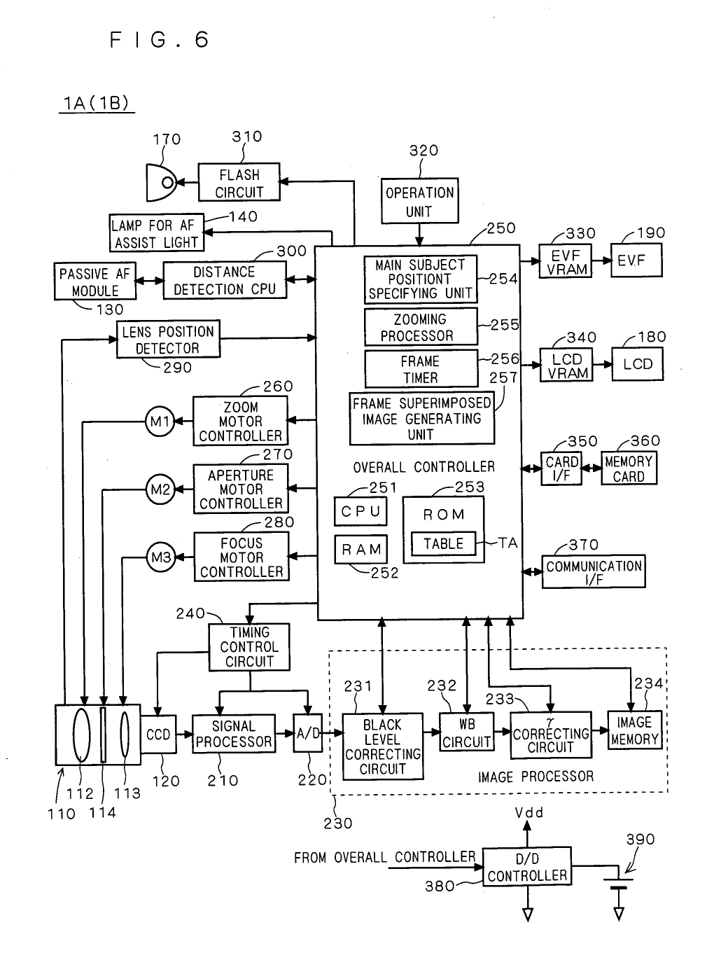

Subsequently, the functional configuration of the digital camera 1A will be described with reference to the block diagram of FIG. 6.

The taking lens 110 having the zoom lens group 112, focus lens group 113 and aperture 114 forms an optical image on the light reception face of the CCD 120.

The CCD 120 photoelectrically converts the optical image into an image signal having color components of R (red), G (green) and B (blue) and outputs the image signal to a signal processor 210. The image signal is a signal train of pixel signals according to a light reception amount of light reception devices (pixels) constructing the CCD 120.

The signal processor 210 performs a predetermined analog signal process on the image signal inputted from the CCD 120. The signal processor 210 has a correlated double sampling (CDS) circuit and an automatic gain control (AGC) circuit. The CDS circuit reduces sampling noise of an image signal. The AGC circuit adjusts the signal level of the image signal. The gain control in the AGC circuit is also used to increase the level of the image signal in the case where proper exposure cannot be obtained by adjusting the aperture diameter of the aperture 114 and the exposure time of the CCD 120.

An A/D converter 220 converts an analog image signal inputted from the signal processor 210 into a digital image signal and outputs the digital image signal as image data to an image processor 230.

The operations of the CCD 120, signal processor 210 and A/D converter 220 are performed synchronously with reference clocks inputted from a timing control circuit 240. The timing control circuit 240 generates reference clocks on the basis of a control signal inputted from an overall controller 250.

An image processor 230 has a black level correcting circuit 231, a white balance (WB) circuit 232, a γ correcting circuit 233, and an image memory 234.

The black level correcting circuit 231 corrects the black level of image data inputted from the A/D converter 220 to a predetermined black level.

The WB circuit 232 performs level conversion of the color components of R, G and B of image data. The level conversion is performed by using a level conversion table inputted from the overall controller 250. The level conversion table is set for each captured image by the overall controller 250.

The γ correcting circuit 233 performs tone transformation on image data inputted from the WB circuit 232. The tone transformation is carried out on the basis of a predetermined level conversion table.

The image memory 234 temporarily stores image data inputted from the γ correcting circuit 233. The image memory 234 has a storage capacity capable of storing image data of one frame.

The digital camera 1A has a zoom motor controller 260, an aperture motor controller 270 and a focus motor controller 280. The zoom motor controller 260, aperture motor controller 270 and focus motor controller 280 supply drive power to a zoom motor M1, an aperture motor M2 and a focus motor M3 on the basis of a zoom control signal, an aperture control signal, and a focus control signal supplied from the overall controller 250, respectively. In such a manner, the overall controller 250 can change the zoom magnification, the aperture diameter, and the focus state of the taking lens 11.

The digital camera 1A has a lens position detector 290 including an encoder for detecting the positions of the zoom lens group 112 and the focus lens group 113. The lens position detector 290 outputs the detected positions of the zoom lens group 112 and the focus lens group 113 to the overall controller 250.

The digital camera 1A has the passive AF module 130 including a sensor chip 131 for distance detection, a distance detection CPU 300 for controlling the passive AF module 130 and analyzing a signal inputted from the passive AF module 130, and the AF illuminator 140.

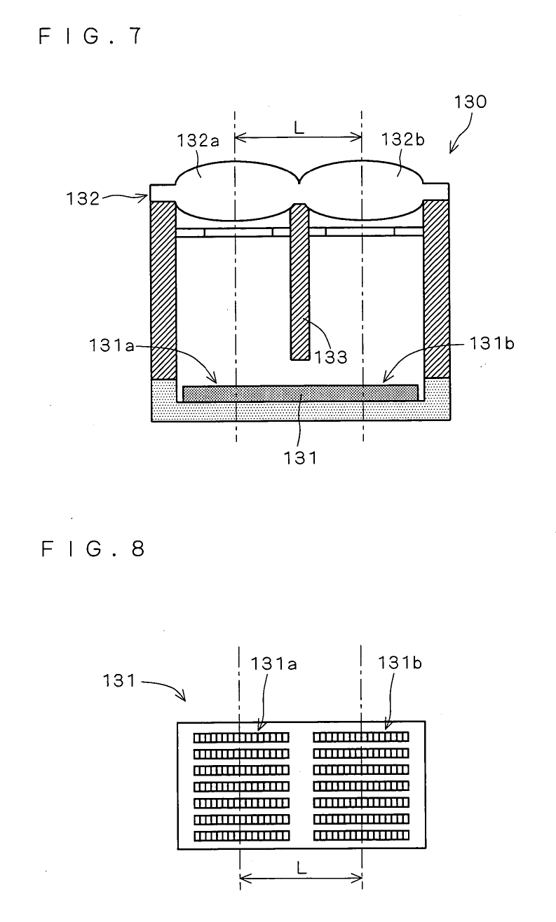

The passive AF module 130 will be described with reference to FIGS. 7 and 8. FIG. 7 is a sectional view of the passive AF module 130. FIG. 8 is a front view of the sensor chip 131 of the passive AF module 130. As shown in FIG. 7, the passive AF module 130 has the sensor chip 131 and a lens group 132. As shown in FIG. 8, on the surface of the sensor chip 131, light reception element groups 131a and 131b in which a plurality of light reception elements are arranged two-dimensionally (which are line sensors of j lines but an area sensor may be alternatively used) are provided. The pair of light reception element groups 131a and 131b are disposed apart from each other only by predetermined distance L. The light reception elements in the light reception element group 131a and those in the light reception element group 131b are arranged in almost the same way. The light reception element groups 131a and 131b can output a light reception signal according to a light reception amount to the distance detection CPU 300.

A pair of lenses 132a and 132b are disposed in a state where their optical axes are apart from each other only by the distance L so that a pair of light images for measuring distance are formed on the light reception element groups 131a and 131b.

Further, the passive AF module 130 has therein a light shielding member 133 for preventing interference between a light image incident via the lens 132a corresponding to the light reception element group 131a and a light image incident via the lens 132b corresponding to the light reception element group 131b.

The distance detection CPU 300 analyzes a light reception signal inputted from the sensor chip 131 of the passive AF module 130 and calculates two-dimensional distance detection information as information of distance from the digital camera 1A to the subject by correlation by using the theory of triangulation. In other words, the distance detection CPU 300 calculates the two-dimensional distance detection information from a deviation amount of the light images in the light reception element groups 131a and 131b. To the calculating process, various known techniques can be applied. Since the light reception face of the sensor chip 131 is disposed almost parallel with that of the CCD 120, the digital camera 1A can measure the distance in the direction almost perpendicular to the light reception face of the CCD 120 in a two-dimensional distance detection area FA almost parallel with the light reception face of the CCD 120. The two-dimensional distance detection area FA includes distance measuring points corresponding to ij small areas of the light reception element group 131a or 131b.

The two-dimensional distance detection information (a set of distance detection results at ij distance detection points) calculated by the distance detection CPU 300 is outputted from the distance detection CPU 300 to the overall controller 250 and is used for AF control in the digital camera 1A and for specifying of a location on a captured image of a main subject. The details will be described later.

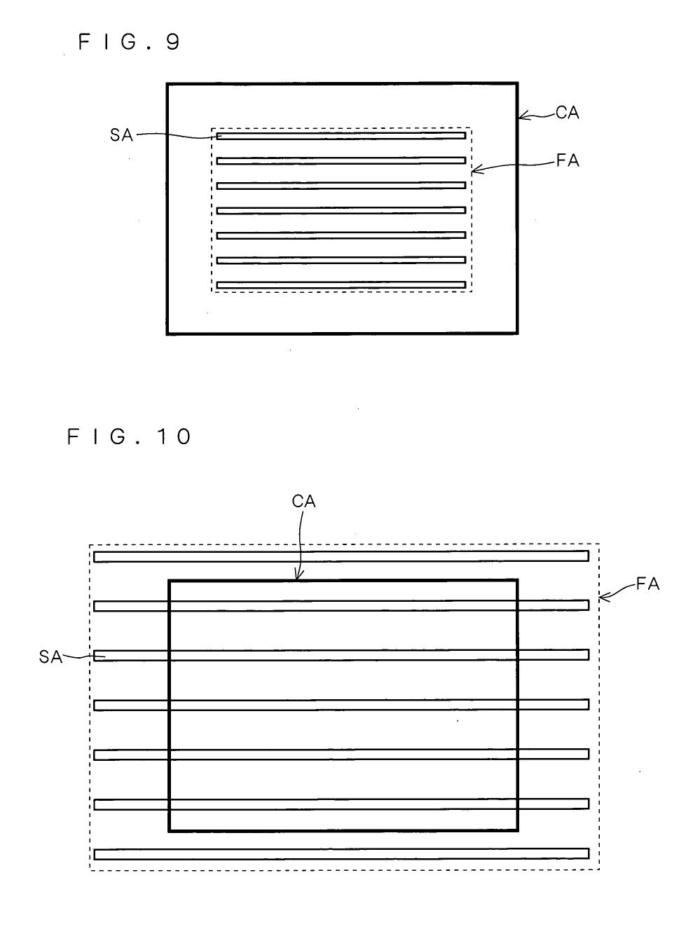

With such a configuration, in the digital camera 1A, an image capturing area CA to be captured by the CCD 120 changes according to the position of the zoom lens group 132 (that is, the magnification of the optical zoom or focal length). On the other hand, the distance detection area FA of which distance is to be measured by the passive AF module 130 is constant. Consequently, the relative size of the image capturing area CA to the distance detection area FA (which is also an area in which the main subject is detected) changes according to the optical zoom magnification. This change will be described with reference to FIGS. 9 and 10. FIG. 9 is a diagram showing the relation between the image capturing area CA (portion surrounded by the solid line) and the distance detection area FA (portion surrounded by the broken line) in the case where the position of the zoom lens group 132 is at the widest angle side (wide angle end: the minimum zoom magnification). FIG. 10 is a diagram showing the relation between the image capturing area CA and the distance detection area FA in the case where the position of the zoom lens group 132 is on the most telephoto side (telephoto end: the maximum zoom magnification). In the digital camera 1A, in the case of the wide angle end (FIG. 9), the image capturing area CA is larger than the distance detection area FA and the size in the vertical and horizontal directions of the distance detection area FA is set to about 70% of that of the image capturing area CA. On the other hand, on the telephoto side (FIG. 10), the size is set so that the distance detection area FA is larger than the image capturing area CA. Specifically, in the digital camera 1A, when the zoom lens group 132 is driven from the wide end to the telephoto end, there is a point that the size of the image capturing area CA and that of the distance detection area FA become almost the same. In FIGS. 9 and 10, sensing areas SA of line sensors of the sensor chip 131, which are discretely disposed are shown. The distance detection area FA is a collection of the sensing areas SA. The density of the sensing areas SA in the distance detection area changes depending on the number of line sensors of the sensor chip 131. The number of line sensors of the sensor chip 131 is properly increased/decreased according to resolution required to detect a main subject of the digital camera 1A.

Referring again to FIG. 6, description will be continued.

The AF illuminator 140 emits light in response to an AF assist light control signal supplied from the overall controller 250.

The digital camera 1A has a flash circuit 310 and the pop-up flash 170. The flash circuit 310 supplies power to the pop-up flash 170 in response to a flash control signal supplied from the overall controller 250.

The digital camera 1A has an operation unit 320. The operation unit 320 includes the above-described shutter button 150, mode setting dial 160 and automatic trimming button 200. The overall controller 250 detects the states of the operation members and reflects the states into the operation of the digital camera 1A.

The digital camera 1A has an EVF VRAM 330 and an LCD VRAM 340 serving as buffer memories of images displayed on the EVF 190 and the LCD 180, respectively The EVF VRAM 330 has a storage capacity capable of storing image data of the same number of pixels as that of the EVF 190, and the LCD VRAM 340 has a storage capacity capable of storing image data of the same number of pixels as that of the LCD 180.

The digital camera 1A has a card interface 350. A memory card 360 is removably loaded into a card slot of the digital camera 100A. The memory card 360 is a nonvolatile memory for storing captured image data. The card interface 350 is an interface for writing/reading image data to/from the memory card 360.

In the image recording standby state of the image recording mode, image signals generated at predetermined time intervals by the CCD 120 are processed by the signal processor 210, A/D converter 220, black level correcting circuit 231, WB circuit 232 and γ correcting circuit 233, and the processed image signals are temporarily stored as image data in the image memory 234. The image data is read by the overall controller 250 and converted to image data having the same number of pixels as that of each of the EVF 190 and the LCD 180. The resultant image data is transferred to the EVF VRAM 330 and the LCD VRAM 340, and is displayed as a live view in each of the EVF 190 and the LCD 180. The user can therefore visually recognize the image of the subject. In the playback mode, image data stored in the memory card 360 is read by the overall controller 250 via the card interface 350 and is subjected to predetermined image processes. The processed image data is converted to image data having the same number of pixels as that of each of the EVF 190 and the LCD 180 and the resultant image data is transferred to the EVF VRAM 330 and the LCD VRAM 340. The image data is played back on the EVF 190 and the LCD 180.

The overall controller 250 is a microcomputer including at least a CPU 251, a RAM 252 and a ROM 253 and controls the operations of the components of the digital camera 1A in a centralized manner in accordance with a program stored in the ROM 253. In the overall controller 250 in FIG. 6, the functions realized by the CPU 251, RAM 252 and ROM 253 are schematically expressed as a main subject position specifying unit 254, a zoom processor 255, a frame timer 256 and a frame superimposed image generating unit 257. The main subject position specifying unit 254 specifies the position of a main subject in a captured image on the basis of the two-dimensional distance detection information supplied from the distance detection CPU 300. The zoom processor 255 realizes various zooming processes which will be described later. The frame timer 256 measures elapsed time since a frame to be described later starts to be displayed on the LCD 180. The frame superimposed image generating unit 257 generates an image on which a frame is superimposed.

The digital camera 1A also has a communication I/F 370 and a D/D controller 380. The communication I/F 370 is an interface for performing communication with an external device connected to the digital camera 1A. A power source battery 390 is a power source for driving the components of the digital camera 1A. The D/D controller 380 converts the voltage of the power source battery 390 to a predetermined voltage Vdd and supplies the predetermined voltage Vdd to the components of the digital camera 1A. The D/D controller 380 operates under control of the overall controller 250.

Detection of Main Subject and Position Specification

In the following, a method of specifying the position of a main subject in a captured image on the basis of the two-dimensional distance detection information generated by the passive AF module 130 and the distance detection CPU 300 will be described. In specifying the position of a main subject, first, the position of a main subject in a light image for distance detection (hereinafter, referred to as distance detection image) is specified from the two-dimensional distance detection information. After that, based on the position of the main subject in the distance detection image, the position of the main subject in the captured image is specified. The specifying process is performed by the main subject position specifying unit 254 in the overall controller 250. Although the main subject to be detected by the digital camera 1A is not limited, the method of detecting a main subject will be described by using the case of detecting a person as a main subject as an example.

Method of Specifying Position of Main Subject in Distance Detection Image from Two-dimensional Distance Detection Information

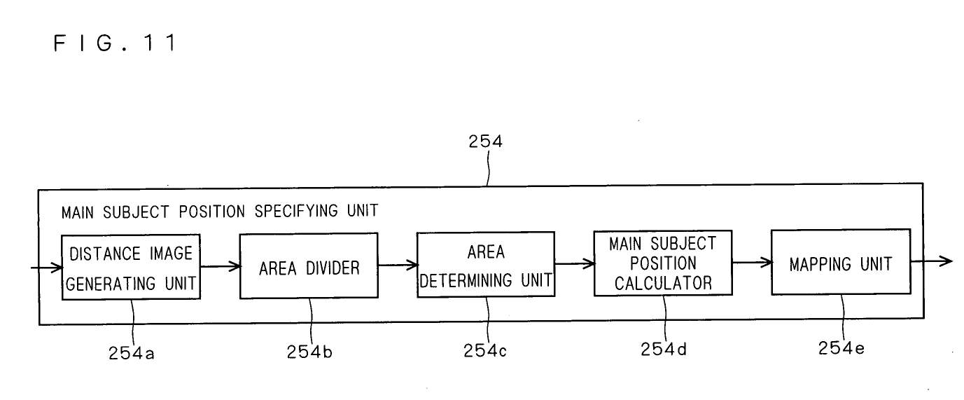

First, the method of specifying the position of a main subject in the distance detection image FI will be described with reference to the block diagram of FIG. 11 showing the configuration of the main subject position specifying unit 254 for detecting a main subject and specifying the position of the main subject.

The main subject position specifying unit 254 has a distance image generating unit 254a for generating a distance image LI in which the two-dimensional distance detection information supplied from the distance detection CPU 300 is plotted to a three-dimensional space. More concretely, the distance image generating unit 254a generates the three-dimensional distance image LI in which a distance detection result in each of distance detection points included in the two-dimensional distance detection area FA is plotted every distance detection point.

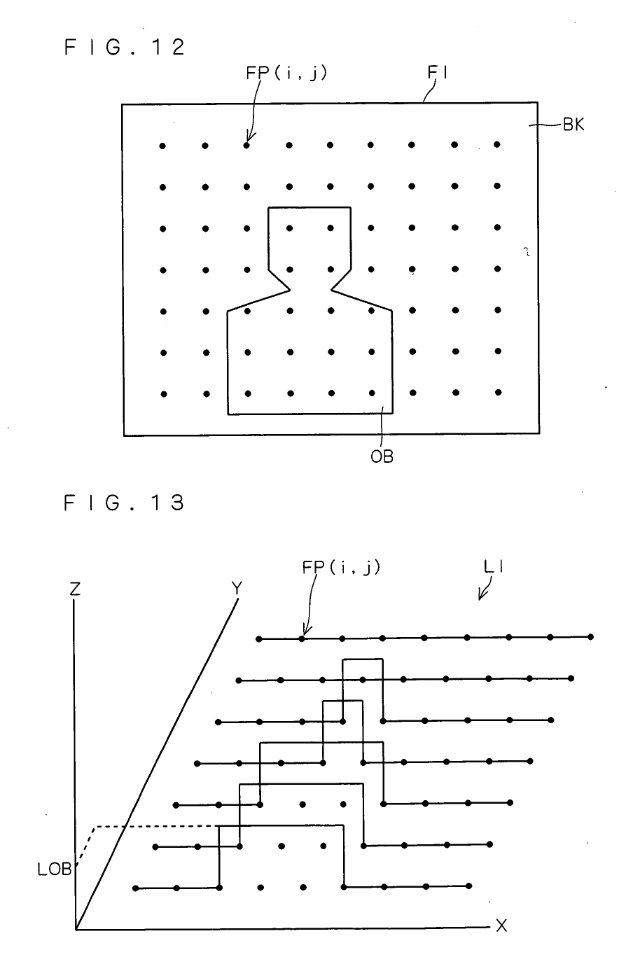

The relation between the distance detection image FI and the distance image LI will be described with reference to FIGS. 12 and 13. FIG. 12 is a diagram in which the distance detection image FI is schematically shown as a line drawing. FIG. 13 shows the distance image LI generated by the distance image generating unit 254a.

In the distance detection image FI of FIG. 12, an object OB is included in a background BK. The distance from the digital camera 1A to the background BK is almost infinite, and it is assumed that the digital camera 1A and the object OB are apart from each other only by a distance LOB. The points FP(i, j) (where 1≦i≦9, 1≦j≦7, and i and j are natural numbers) in the schematic diagram of FIG. 12 are ij pieces (in this case, 9×7=63 which may be increased/decreased according to required resolution), which are shown for convenience, of distance detection points and are not included in the actual distance detection image FI. Each of the natural numbers i and j is an index indicative of the position in the lateral and vertical directions of the distance detection point.

On the other hand, in the distance image LI in FIG. 13, distance detection points FP(i j) are disposed in an XY plane in an XYZ space in which the distance image LI is generated. Further, the distance detection result at each distance detection point FP(i, j) is plotted in the Z-axis direction. The X-axis and Y-axis directions correspond to the horizontal and vertical directions, respectively, of the distance detection area FI of a two-dimensional area.

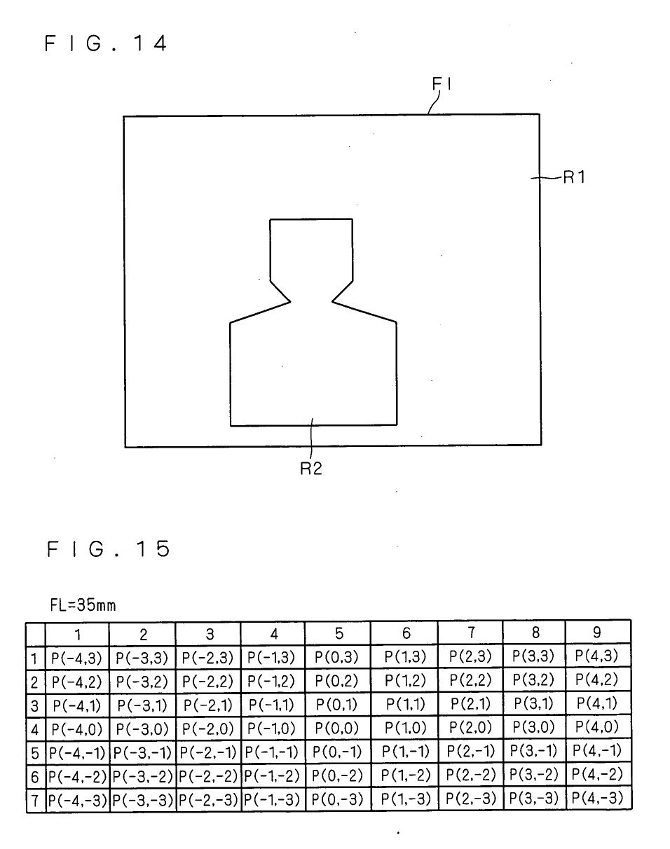

Further, the main subject position specifying unit 254 has an area divider 254b. The area divider 254b divides the distance detection image FI every area in which almost the same distance detection results are obtained by using the three-dimensional distance image LI. For example, in the case where the distance image LI shown in FIG. 13 is obtained, the distance detection image FI is divided into an area RI in which the distance is almost infinite and an area R2 in which the distance is LOB as shown in FIG. 14.

Further, the main subject position specifying unit 254 has an area determining unit 254c for determining whether the divided areas R1 and R2 are areas of a person (main subject) or not. The area determining unit 254c determines whether the areas R1 and R2 are areas of a human being or not in consideration of the shape and size converted in real dimension of each of the areas R1 and R2 and the magnification of the digital camera 1A. To the determination, for example, a determining method using a body width, a face width and a width ratio disclosed in Japanese Patent Application Laid-Open No. 2002-298138 can be applied. Information of the distance detection point included in the area determined as an area of a human being by the area determining unit 254c is outputted to a main subject position calculator 254d. In such a manner, a human being as a main subject is detected by the distance image generating unit 254a, area divider 254b and area determining unit 254c.

The main subject position calculator 254d specifies the center of gravity position of the human being on the basis of the information of the distance detection point included in the area of the human being. After that, the center of gravity position is used as the position of the main subject.

Method of Specifying Position of Main Subject in Captured Image from Position of Main Subject in Distance Detection Image

Next, a method of specifying the position of the subject in the captured image CI from the position of the main subject in the distance detection image FI will be described. To specify the position of the main subject, it is sufficient to determine the correspondence relation between each point in the distance detection image FI and each point in the captured image CI, that is, a method of mapping from a point in the distance detection image FI to a point in the captured image CI. In other words, it is sufficient to associate the two-dimensional distance detection area FA and the captured area CA regarding the distance detection image FI. In the following, the corresponding method will be described. Since the angle of view of the distance detection image FI (distance detection area FA) relative to the angle of view of the captured image CI (captured area CA) changes according to the focal length (zoom magnification), the focal length has to be considered in the association. The process is performed by a mapping unit 254e provided for the main subject position specifying unit 254.

A case where the distance detection area FA is divided into blocks of 7 columns and 9 rows and the captured area CA is divided into blocks of 11 columns and 13 rows will be considered as an example. The block in the i-th column and j-th row obtained by dividing the distance detection area FA is expressed as a symbol L(i, j), and the block in the x-th column and y-th row obtained by dividing the captured image area CA is expressed as a symbol P(x, y). In the digital camera 1A, a table TA in which the relation between a block L(i, j) and a block P(x, y) is written every focal length is stored in the ROM 253.

Examples of the relation between the block L(i, j) and the block P(x, y) of each focal length are shown in Tables of FIGS. 15 to 17. FIGS. 15, 16 and 17 show the relation between the block L(i, j) and the block P(x, y) in the case where the focal length FL is 35 mm, 70 mm and 105 mm (35 mm film camera equivalent), respectively. The lateral direction in the tables in matrix form of FIGS. 15 to 17 corresponds to the lateral direction of the distance detection area FA. The vertical direction of the tables each having a matrix form of FIGS. 15 to 17 corresponds to the vertical direction of the distance detection area FA. In each of columns of the matrix-shaped tables of FIGS. 15 to 17, a block P(x, y) corresponding to a block L(i, j) of the row and column to which the column belongs is written.

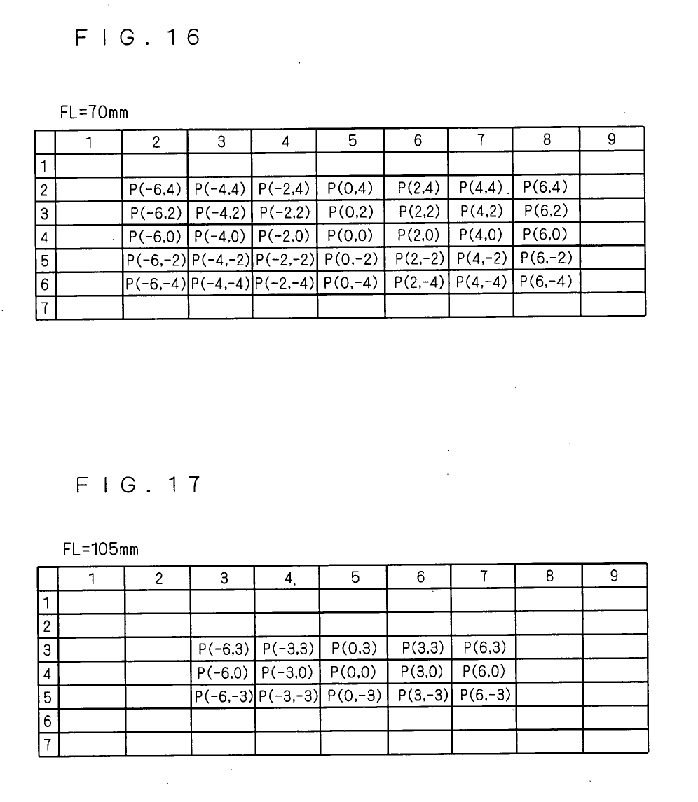

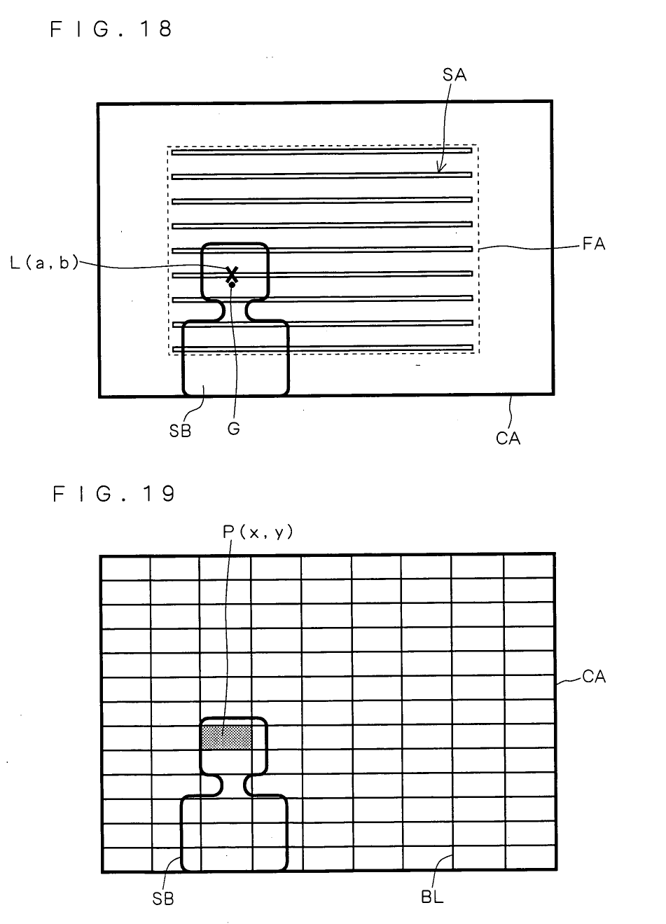

In the case of FIG. 15, since the image capturing area CA is larger than the distance detection area FA, the block P(x, y) which is not written in the table exists. On the other hand, in the case of FIGS. 16 and 17, the distance detection area FA is larger than the image capturing area CA, so that there are columns in which a corresponding block P(x, y) is not written. Therefore, between the focal length 35 mm of FIG. 15 and the focal length 70 mm of FIG. 16, the focal length FL in which the distance detection area FA and the image capturing area CA almost coincide with each other exists.

A method of specifying the position of a main subject in the captured image CI will be described in more detail with reference to FIGS. 18 and 19. FIGS. 18 and 19 are diagrams schematically showing the image capturing area CA including the main subject SB. In FIG. 18, in addition to the image capturing area CA and the main subject SB, the position G of the center of gravity of the main subject, the distance detection area FA, and the sensing area SA in the distance detection area FA are written. FIG. 19, in addition to the image capturing area CA and the main subject SB, a border line BL as a border in the case of dividing the image capturing area CA into blocks are written. Those are written for convenience of explanation and are not included in the actual captured image CI and the distance detection image FI. The mapping unit 254e specifies the block L(a, b) including the center of gravity G of the main subject SB. Further, the mapping unit 254e specifies the block P(x, y) corresponding to the block L(a, b) by referring to the table TA stored in the ROM 253. By the operations, the position of the main subject in the captured image CI is specified. In the following, the position is specified by the specified block P(x, y).

Zooming Operation of Digital Camera

The zooming operation of the digital camera 1A will now be described. In the following, the zooming operation automatically executed by the digital camera 1A, which is triggered by depression of the automatic trimming button 200 will be described. General optical zoom operation of changing the optical zoom magnification by manually operating the up and down push buttons UP and DN of the cross switch 205 will not be described. In the following, a fixed zoom process and a stationary subject zoom process as basic operation units in the zooming operation in the digital camera 1A will be described first. After that, the zooming operation will be described generally. The fixed zoom process and the stationary subject zooming process are electronic zoom process for generating a pseudo zoom image by extracting a partial area in the captured image CI. In the electronic zoom process, by falsely changing the focal length, the pseudo angle of view is changed.

Fixed Electronic Zoom Process

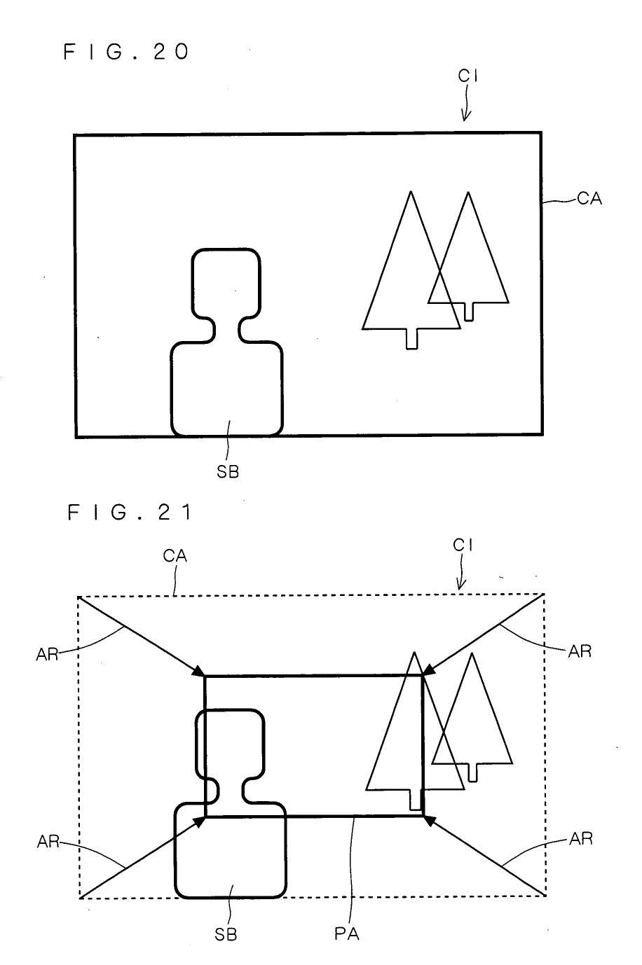

The fixed electronic zoom process will be described with reference to FIGS. 20 and 21. FIGS. 20 and 21 are diagrams in which the captured image CI is schematically illustrated in line drawing. In FIG. 21, the partial area PA to be extracted in the case of generating the electronic zoom image is shown in the image capturing area CA of the captured image CI. The partial area PA and the arrow AR are shown for convenience of description and are not included in the actual captured image CI (also in the following description).

In the image capturing area CA in each of FIGS. 20 and 21, a person which can be detected as the main subject SB is captured in the digital camera 1A. However, in the fixed electronic zoom process, different from the stationary subject electronic zoom process, the position of the main subject SB is not considered. More concretely, in the fixed electronic zoom process, zoom-in is performed so that the center of the partial area PA coincides with the center of the image capturing area CA. Therefore, to capture the main subject SB in the center of a zoom image, there is a case that the user has to perform framing at the time of zoom-in. At the time of zoom-in, the magnification for the captured image CI to a zoom image is determined in accordance with time in which the automatic trimming button 200 is pressed.

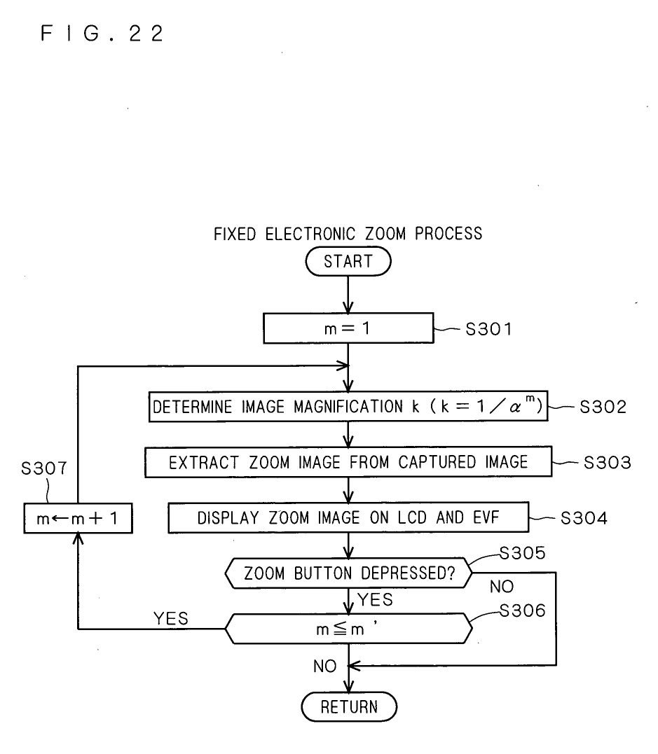

An operation flow of a subroutine of the fixed electronic zoom process at the time of zoom-in will now be described with reference to the flowchart of FIG. 22. As will be described later, the operation flow is executed during operation which is started by depression of the automatic trimming button 200.

In the first step S301 of the fixed electronic zoom process, the zoom processor 255 initializes a parameter “m” used to determine a magnification “k” for the captured image CI to obtain a zoom image (m=1). The operation flow moves to step S302.

In step S302, the zoom processor 255 determines the image magnification “k” by using Equation 1. Although a concrete value of a constant α is not limited, α is set to 0.9 in this case. After determining the image magnification “k” operation flow moves to step S303.

$$k = \frac{1}{{α}^{m}} ( 0 \leq α \leq 1 ) \qquad Equation 1$$

In step S303, the zoom processor 255 extracts (trims out) the partial area PA in the captured image CI, thereby generating a zoom image. At this time, the center of the partial area PA coincides with the center of the image capturing area CA. The angle of view of the zoom image is k⁻¹ times as large as that of the captured image CI. In the case where step S303 is executed first in the fixed electronic zoom process, the angle of view of the zoom image becomes 0.9 time of the angle of view of the captured image CI.

In step S304 subsequent to step S303, the zoom processor 255 enlarges the zoom image generated in step S303 to a display image having the same number of pixels as that of the LCD 180 and the EVF 190 and transfers the enlarged image to the LCD VRAM 340 and the EVF VRAM 330. The zoom image obtained by enlarging the image included in the partial area PA by “k” times in the vertical and lateral directions is displayed on the LCD 180 and EVF 190. By the process, on the LCD 180 and EVF 190, the zoom image having the angle of view smaller than that of the captured image CI is displayed in the same size as that of the captured image CI. Consequently, visual effects similar to those in the case where the focal length of the taking lens 110 increases are obtained. After completion of the display process, the operation flow moves to step S305.

In step S305, the zoom processor 255 detects the state of the automatic trimming button 200 and executes a branching process according to the state. Concretely, when it is detected that depression of the automatic trimming button 200 continues, the zoom processor 255 continues the operation flow of the subroutine of the fixed electronic zoom process and moves to step S306. On the other hand, when depression of the automatic trimming button 200 is not detected (it is detected that depression is canceled), the zoom processor 255 finishes the subroutine of the fixed electronic zoom process.

In step S306 subsequent to step S305, the zoom processor 255 compares the parameter “m” with a predetermined threshold m′. When the parameter m is larger than the threshold m′, the zoom processor 255 finishes the subroutine of the fixed electronic zoom process. On the other hand, when the parameter m is equal to or smaller than the threshold m′, the operation flow moves to step S307. It can prevent the image magnification k from becoming larger than k′=α^{-m′}. In other words, the upper limit α^{-m}′ is set for the image magnification k.

In step S307, the zoom processor 255 increments the parameter “m” “m+1”. The operation flow shifts to step S302. Consequently, the image magnification k increases.

By the operation flow, while the automatic trimming button 200 is depressed, the image magnification k gradually increases (the size of the partial area PA gradually decreases). When the depression of the automatic trimming button 200 is interrupted or the image magnification k reaches the upper limit α^{-m′}, enlargement of the image by the electronic zoom is stopped. In other words, according to the depression time of the automatic trimming button 200, the image magnification k (the size of the partial area PA) changes. On the other hand, in the case of zoom-out, the down push button DN of the cross switch 205 is depressed. By the depression, in a manner opposite to FIG. 22, the value of m is decremented to decrease the image magnification k. When m becomes 0, the image magnification k reaches the lower limit value of 1, and the electronic zoom is finished. Also in the case where it is detected that depression of the cross switch 205 is stopped, the electronic zoom is finished.

Stationary Subject Electronic Zoom Process

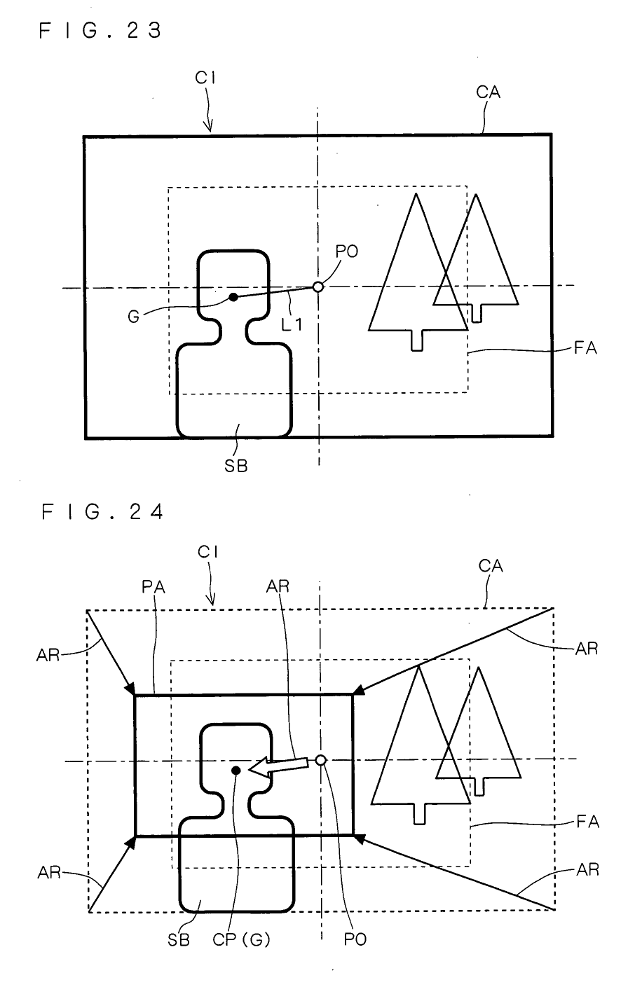

A stationary subject electronic zoom process adapted to zoom in on a stationary main subject will now be described with reference to FIGS. 23 and 24. FIGS. 23 and 24 are diagrams schematically illustrating the captured image CI as a line drawing. In FIGS. 23 and 24, the distance detection area FA as an area in which the main subject SB is to be detected is illustrated in the image capturing area CA of the captured image CI. In FIG. 24, the partial area PA to be extracted in the case of generating a zoom image is illustrated in the image capturing area CA. Since the distance detection area FA is illustrated for convenience of description, it is not included in the actual captured image CI (also in the following description).

In the image capturing area CA in FIGS. 23 and 24, a person to be detected as a main subject SB is captured in the digital camera 1A. In the stationary subject electronic zoom process, the center CP of the partial area PA is determined on a line LI connecting the center P0 of the image capturing area CA and the position G of the main subject SB. FIG. 24 shows, as an example, a state where the center CP of the partial area PA is determined in the position G of the main subject SB. In the stationary subject electronic zoom process, the center CP of the partial area PA on the line L1 and the size of the partial area PA are determined according to depression time of the automatic trimming button 200.

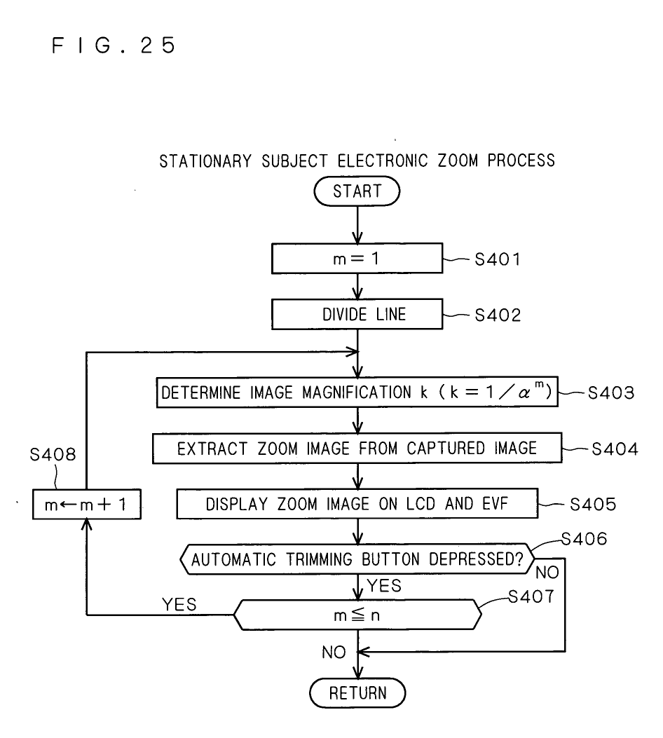

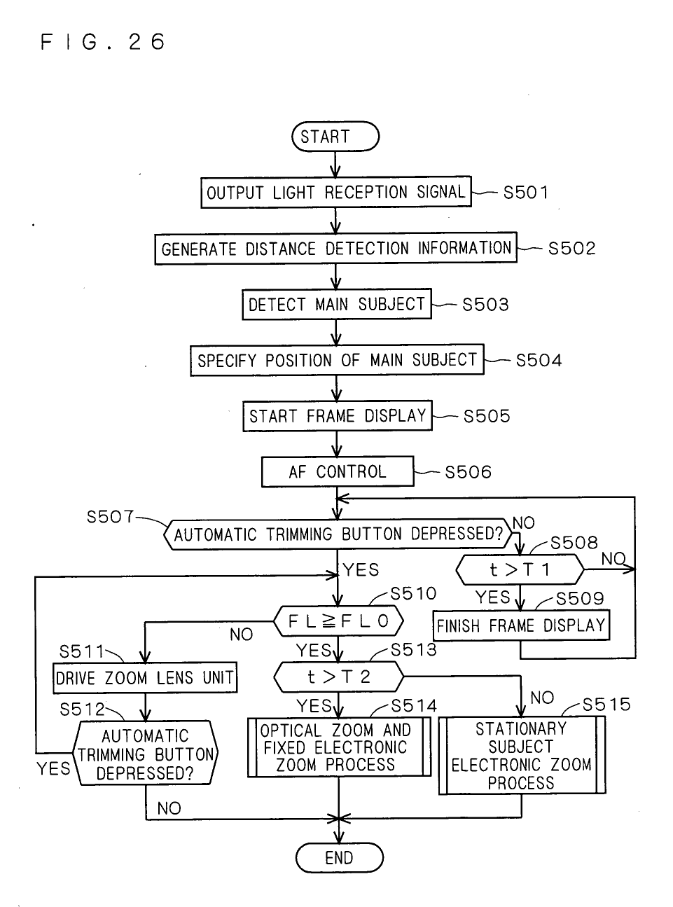

The operation flow of the subroutine of the stationary subject electronic zoom process at the time of zoom-in will now be described with reference to the flowchart of FIG. 25. The operation flow is also executed during an operation started by depression of the automatic trimming button 200.

In the first step S401 of the stationary subject electronic zoom process, the zoom processor 255 initializes the parameter “m” used to determine the magnification “k” (m=1). The operation flow moves to step S402.

In step S402, the zoom processor 255 divides the line LI connecting the center P0 and the position G of the main subject SB into n lines. Although a concrete value of the constant n is not limited, it is assumed here that n=10. In the following, both ends and division points of the line LI will be expressed as points P0, P1, . . . , and P10 in order from the side close to the center P0. After completion of the dividing process, the operation flow shifts to step S403.

In step S403, in a manner similar to step S302 of the subroutine of the fixed electronic zoom process, the zoom processor 255 determines the image magnification k. After the image magnification k is determined, the operation flow moves to step S404.

In step S404, the zoom processor 255 extracts (trims) the partial area PA in the captured image CI, thereby generating a zoom image. At this time, the angle of view of the zoom image is k⁻¹ times as that of the captured image CI like in step S303 of the subroutine of the fixed electronic zoom process. However, the center CP of the partial area PA is, different from step S303 of the subroutine of the fixed electronic zoom process, a point Pm. In the stationary subject electronic zoom process, the center CP of the partial area PA moves from the center P0 of the captured image CI toward the position G of the main subject SB. In other words, the destination (or direction of movement) of the area to be trimmed to obtain a zoom image is determined on the basis of the position G of the main subject SB.

In step S405 subsequent to step S404, in a manner similar to step S304 of the subroutine of the fixed electronic zoom process, the zoom image is displayed on the LCD 180 and EVF 190. The operation flow moves to step S406.

In step S406, the zoom processor 255 detects the state of the automatic trimming button 200 and executes a branching process in accordance with the state. Concretely, when it is determined that depression of the automatic trimming button 200 continues, the zoom processor 255 continues the operation flow of the subroutine of the stationary subject electronic zoom process and moves to step S407. On the other hand, when depression of the automatic trimming button 200 is not detected (it is detected that depression is canceled), the zoom processor 255 finishes the subroutine of the stationary subject electronic zoom process.

In step S407, the zoom processor 255 compares the parameter “m” with a threshold “n” (=10). When the parameter m is larger than the threshold n, the zoom processor 255 finishes the subroutine of the stationary electronic zoom process. On the other hand, when the parameter m is equal to or less than the threshold n, the operation flow moves to step S408. It can prevent the image magnification k′ from becoming larger than α^{-n′}. In other words, the upper limit α^{-n′}is set for the image magnification k.

In step S408, the zoom processor 255 increments the parameter “m” “m+1”. The operation flow shifts to step S403. Consequently, as the image magnification k increases, the center CP of the partial area PA approaches the position G of the main subject SB.

By the operation flow, while the automatic trimming button 200 is depressed, the image magnification k gradually increases. Further, in the stationary subject electronic zoom process, different from the fixed electronic zoom process, while the automatic trimming button 200 is depressed, the center CP of the partial area PA gradually moves from P0 toward P10. In other words, according to depression time of the automatic trimming button 200, the image magnification k (size of the partial area PA) and the center CP of the partial area PA synchronously change. When the depression of the automatic trimming button 200 is interrupted or the center CP of the partial area PA reaches the position G of the main subject SB, image enlargement by the electronic zoom is stopped. By such an operation flow, the main subject SB which does not exist in the center of the captured image CI can be automatically moved to the center of a zoom image. Thus, a framing operation at the time of electronic zooming becomes unnecessary and a camera shake can be prevented. By changing the depression time of the automatic trimming button 200, the degree of zoom-in can be changed. On the other hand, at the time of zoom-out, in a manner similar to the case of the fixed electronic zooming, the down push button DN of the cross switch 205 is depressed. By the depression, in a manner opposite to FIG. 25, the value of m is decremented to 0 to decrease the image magnification k. At this time, in a manner opposite to step S404, the center CP of the partial area PA moves from the position G of the main subject SB toward the center P0 of the captured image CI. When the image magnification k reaches 1, the center CP of the partial area PA coincides with the center P0 of the captured image CI, and the electronic zoom is finished. Also in the case where it is detected that depression of the cross switch 205 is stopped, the electronic zoom is finished.

Whole Zooming Operation

The whole zooming operation of the digital camera 1A will now be described by referring to the flowchart of FIG. 26.

The flowchart of FIG. 26 is started in response to turn on of the digital camera 1A in an image capturing state or an image capturing state is set from another state. The electronic zoom is canceled irrespective of the state before that.

In the first step S501 of the operation flow, a light reception signal is outputted from the passive AF module 130 to the distance detection CPU 300. The operation flow moves to step S502.

In step S502, the distance detection CPU 300 generates distance detection information by using the light reception signal inputted from the passive AF module 130. The distance detection information is outputted from the distance detection CPU 300 to the main subject position specifying unit 254. After outputting the distance detection information, the operation flow shifts to step S503.

In step S503, the main subject position specifying unit 254 detects the main subject SB on the distance detection image FI by using the distance detection information inputted from the distance detection CPU 300. Further, the main subject position specifying unit 254 specifies the position of the main subject SB in the distance detection image FI. The operation flow moves to step S504.

In step S504, the main subject position specifying unit 254 specifies the position G of the main subject SB in the captured image CI from the position of the main subject SB in the distance detection image FI. The position G of the main subject SB specified in step S504 is used to, for example, determine the destination of the center CP of the partial area PA in the stationary subject electronic zoom process executed in a process afterward.

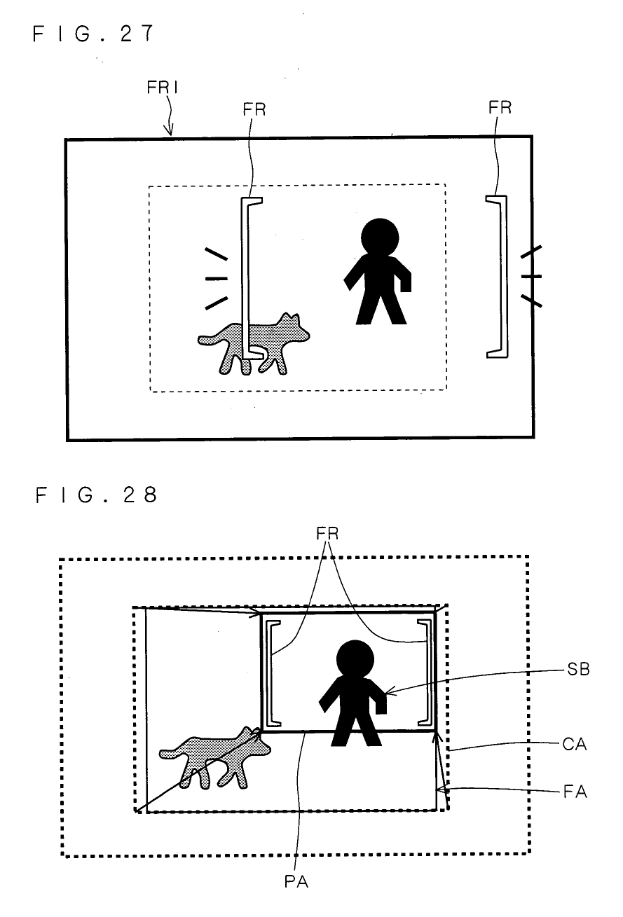

In step S505 subsequent to step S504, a frame superimposed image FRI obtained by superimposing the frame FR having, as the center, the position G of the main subject SB specified in step S504 on the captured image CI is generated by the frame superimposed image generating unit 257. The frame superimposed image FRI is transferred to the EVF VRAM 330 and LCD VRAM 340. The frame superimposed image FRI is displayed as a live view on the EVF 190 and LCD 180. FIG. 27 is a diagram schematically illustrating the state where the frame FR is superimposed on the captured image CI. The frame FR in the first preferred embodiment shows the size of the partial area PA at the upper limit of the image magnification k. In the example of FIG. 27, the frame FR is indicated by a pair of parentheses but the shape of the frame FR is not limited In the case where the position G of the main subject SB is determined, a figure including the position G and the upper limit of the image magnification k, by which the user can visually recognize the information can be used as the frame FR. Display of the frame FR makes the user easily recognize the maximum magnification of an electronic zoom. Consequently, the user can easily know the necessity of electronic zooming and the timing of stop. In the digital camera 1A, the frame timer 256 is start upon start of display of the frame FR, and measurement of frame display time “t” starts. After completion of the processes, the operation flow moves to step S506.

In step S506, the digital camera 1A executes an AF control on the basis of a result of measurement of distance in the position G of the main subject SB.

In step S507 subsequent to step S506, the zoom processor 255 detects the state of the automatic trimming button 200 and executes a branching process in accordance with the detected state. Concretely, when depression of the automatic trimming button 200 is detected, the zoom processor 255 moves to step S510. On the other hand, when depression of the automatic trimming button 200 is not detected, the operation flow moves to step S508.

Steps S508 and S509 are processes executed when depression of the automatic trimming button 200 is not detected in step S507.

In step S508, the zoom processor 255 compares the frame display time “t” measured by the frame timer 256 with a predetermined threshold T1. When the frame display time t is larger than the threshold T1, the operation flow moves to step S509. On the other hand, when the frame display time t is equal to or smaller than the threshold T1, the operation flow returns to step S507.

In step S509, the superimpose display of the frame FR on the LCD 180 and EVF 190 is canceled. Even when the display of the frame FR is canceled, measurement of the frame display time “t” continues until the end of the whole operation flow. A loop operation from step S507 to step S509 is finished whether the automatic trimming button 200 is depressed or another operation such as depression of the shutter button 150 is performed.

By steps S507 to S509, after start of display of the frame superimposed image FRI, time in which the automatic trimming button 200 is not detected becomes longer than the predetermined time T1, display of the frame FR is canceled.

In step S510, the zoom processor 255 compares with focal length FL of the taking lens 110 with a predetermined threshold FLO and performs the branching process. The threshold FL0 is focal length at which the image capturing area CA and the distance detection area FA almost coincide with each other. FIG. 29 schematically illustrates a state where the image capturing area CA and the distance detection area FA almost coincide with each other. When the focal length FL is smaller than the threshold FL0 (when the image capturing area CA is larger than the distance detection area FA), a portion in which the main subject SB cannot be detected exists in the peripheral portion of the image capturing area CA, so that the operation flow shifts to step S511 and optical zooming is performed. On the other hand, when the focal length FL is equal to or lager than the threshold FL0, the main subject SB can be detected in the entire image capturing area CA, so that the operation flow shifts to step S513 and operation afterward including the stationary subject zooming process.

In steps S511 and S512, an optical zoom process is executed.

In step S511, the zoom processor 255 outputs a control signal to the zoom motor controller 260 and increases the focal length FL of the zoom lens group 112 only at a predetermined pitch ΔFL. This operation corresponds to zoom-in in the digital camera 1A. The operation flow shifts to step S512.

In step S512, the zoom processor 255 detects the state of the automatic trimming button 200 and executes a branching process according to the detected state. Concretely, when it is determined that depression of the automatic trimming button 200 continues, the operation flow returns to step S510. On the other hand, when depression of the automatic trimming button 200 is not detected (when end of depression is detected), the operation flow of the zooming process is finished.

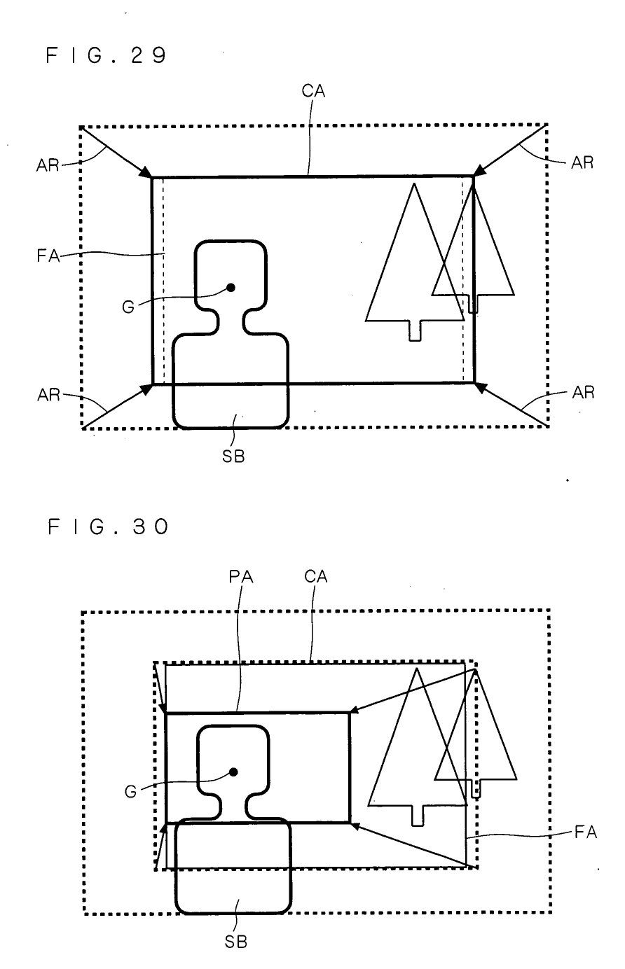

By steps S510 to S512, when the focal length FL is smaller than the threshold FL0, that is, when the image capturing area CA is larger than the distance detection area FA, the magnification of the optical zoom gradually increases while the automatic trimming button 200 is depressed. When the zoom-in is performed until the state where the image capturing area CA and the distance detection area FA almost coincide with each other (state of FIG. 29), the zoom-in by the optical zoom is finished. In the case where the depression state of the automatic trimming button 200 continues even at the time point when the zoom-in is performed by the optical zoom until the image capturing area CA and the distance detection area FA coincide with each other, the operation flow shifts to step S513 followed by steps S514 and S515. In other words, when the image capturing area CA is larger than the distance detection area FA, the optical zoom process in steps S511 and S512 is performed prior to the fixed electronic zoom process and the stationary subject electronic zoom process. By preliminarily making the image capturing area CA and the distance detection area FA almost coincide with each other by the optical zoom, the position of the main subject can be specified in almost the entire image capturing area CA in the stationary subject electronic zoom process. As shown in FIG. 30, the whole image capturing area CA can be used as the partial area PA. In the case where the angle of view of a final zoom image is the same, deterioration in picture quality (resolution) can be prevented in the case where the optical zooming process is performed as compared with the case where the optical zooming process is not performed.

In step S513, the zoom processor 255 compares the frame display time “t” with a predetermined threshold T2 (T1<T2) and performs a branching process. When the frame display time “t” larger than the threshold T2, the operation flow shifts to step S514. On the other hand, when the frame display time “t” equal to or less than the threshold T2, the operation flow shifts to step S515.

In step S514, the optical zoom is continuously performed. After the lens reaches the telephoto end, the above-described fixed electronic zoom process is executed. In step S515, the above-described stationary subject electronic zoom process is executed. In the case where the frame FR is displayed on the LCD 180 and EVF 190, the stationary subject electronic zoom is executed. In the case where the frame FR is not displayed, the fixed electronic zoom process is executed. Therefore, the user can recognize the zooming process to be executed by checking whether the frame FR is displayed on the LCD 180 and EVF 190 or not. It becomes easier to make the digital camera 1A execute a desired zooming process. Further, as shown in FIG. 28, in the stationary subject electronic zoom process, the partial area PA changes so as to approach the frame FR. Consequently, by referring to the frame FR, the user can predict a change in composition by zooming more easily. After completion of the process in steps S514 and S515, the whole zooming operation is finished.

When depression of the automatic trimming button 200 is canceled and, after that, the automatic trimming button 200 is depressed again, the operation of FIG. 26 is performed again.

When the down push button DN of the cross switch 205 is operated after depression of the automatic trimming button 200 is canceled or after the image magnification k in the fixed electronic zoom process or stationary subject electronic zoom process reaches the upper limit and the zooming operation in FIG. 26 is finished, a zoom-out operation is carried out. In the case where the state at the end of the zooming operation occurs during the optical zoom in steps S510 to S512, the zoom-out is performed by the optical zoom. On the other hand, when the state at the end of the zooming operation occurs during or after the fixed electronic zoom process and the stationary subject electronic zoom process of steps S514 and S515, the zoom-out is performed by the electronic zoom by the procedure as described with reference to FIGS. 22 and 25. After the image magnification k becomes 1, the zoom-out is performed continuously by the optical zoom.

When the depression of the down push button DN of the cross switch 205 is canceled after or during the zoom-out, the electronic zoom or optical zoom is finished.

Others

Case Where Plural Main Subjects are Detected

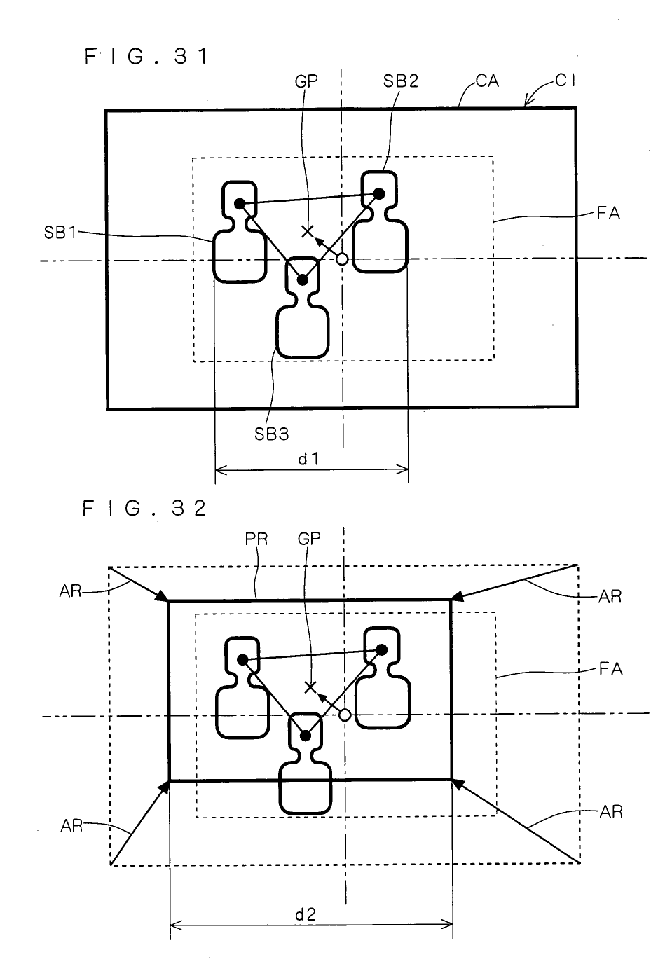

In the above description, the case where the single subject SB is detected has been described as an example. In the case where a plurality of persons are captured in the image capturing image CI as shown in FIG. 31, a plurality of main subjects SB1 to SB3 are detected. In this case, as shown in FIG. 32, the center of gravity GP of the plurality of main subjects SB1 to SB3 as a whole can be used as a destination of the center CP of the partial area PA.

Maximum Magnification

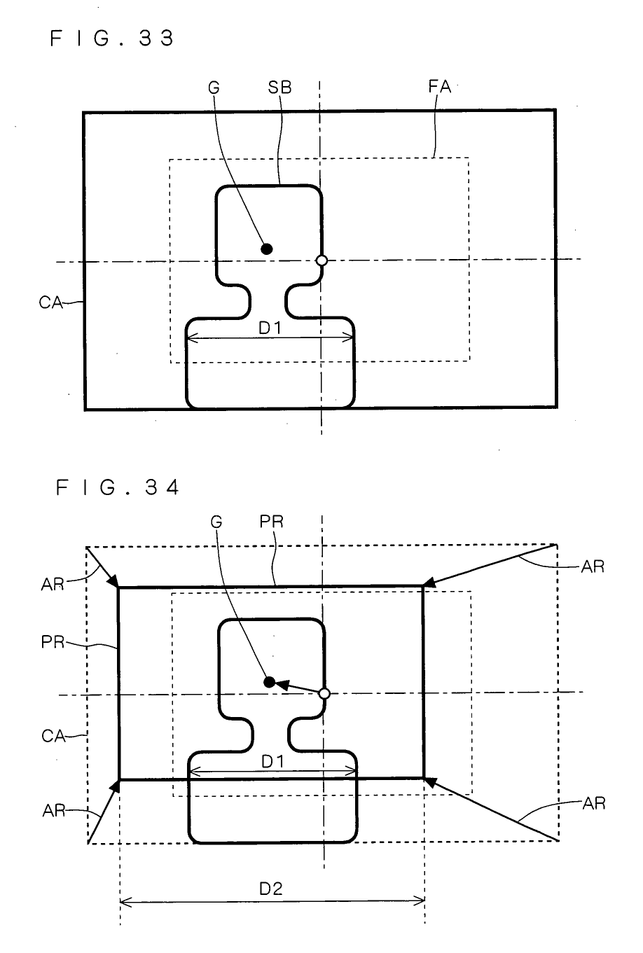

In the above description, the maximum zoom magnification is the predetermined magnification, that is, a predetermined upper limit is set for the image magnification k. Alternately, the maximum zoom magnification may be determined in consideration of the size of the main subject SB. For example, the maximum width D1 may be calculated from the shape of the main subject SB in the main subject position specifying unit 254 as shown in FIG. 33 and width D2 of the partial area PA at the time of the maximum magnification of a zoom image may be determined by Equation 2 as shown in FIG. 34.
D2=2×D1 Equation 2

By determining such width, the main subject SB can be prevented from lying off the partial area PA at the time of zoom-in.

Second Preferred Embodiment

A digital camera 1B of a second preferred embodiment has a configuration similar to that of the digital camera 1A of the first preferred embodiment shown in FIGS. 1 to 6. However, a program stored in the ROM 253 of the digital camera 1B is different from that stored in the ROM 253 of the digital camera 1A. Consequently, the digital camera 1B has a mode of moving subject electronic zoom in addition to the stationary subject electronic zoom. More concretely, in the stationary subject electronic zoom of the digital camera 1A, the destination of the center of a zoom image is determined on the basis of the position of the detected main subject SB itself. In the moving subject zoom of the digital camera 1B, when the main subject SB is moving, the destination of the center of a zoom image can be determined in consideration of movement of the main subject SB.

Zooming Operation of Digital Camera

The digital camera 1B has, basis units of the zooming operation, a fixed electronic zoom process, a moving subject zooming process adapted to zoom in on a moving subject, and a stationary subject zooming process adapted to zoom in on a stationary subject. The fixed electronic zoom process and the stationary subject electronic zoom process of the digital camera 1B are similar to those of the digital camera 1A, so that their detailed description will not be repeated here. In the following, the moving subject electronic zoom process will be described.

Moving Subject Electronic Zoom Process

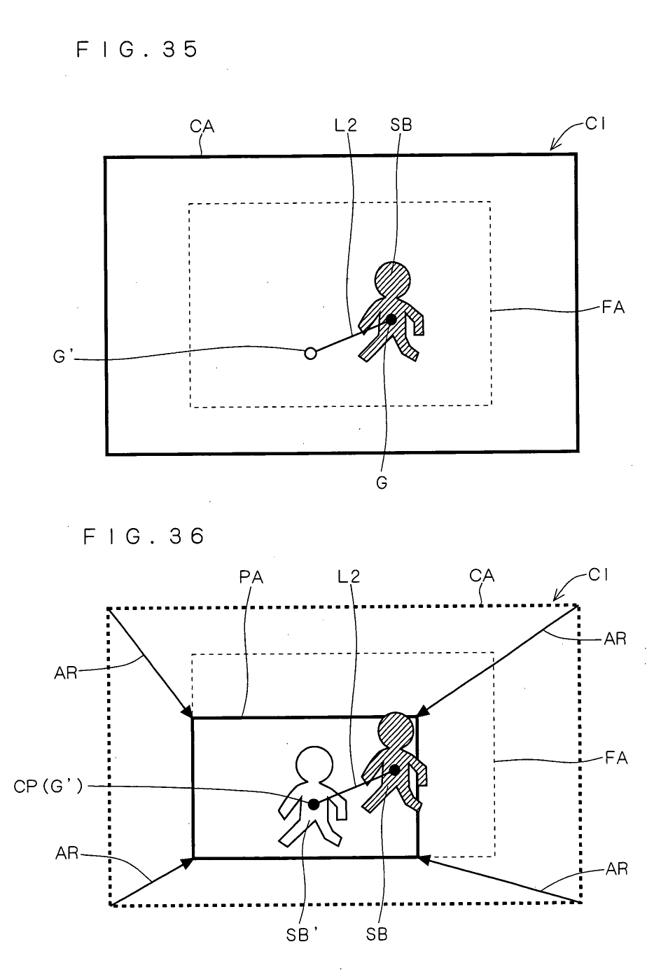

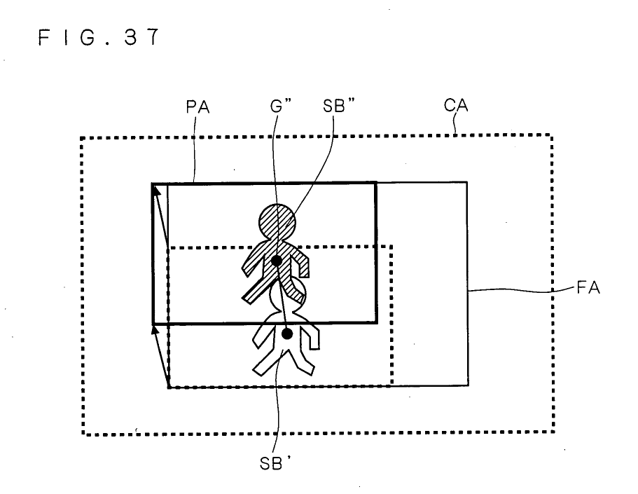

The moving subject electronic zoom process adapted to zoom in on a moving subject will be described with reference to FIGS. 35, 36 and 37. FIGS. 35, 36 and 37 are diagrams each schematically illustrating the captured image CI as a line drawing. In FIGS. 35, 36 and 37, the distance detection area FA as an area for detecting the main subject SB is shown in the image capturing area CA of the captured image CI. In FIGS. 36 and 37, the partial area PA to be extracted in the case of generating a zoom image is shown in the image capturing area CA.

At the angle of view of the image capturing image CI in each of FIGS. 35, 36 and 37, a person to be detected as the main subject SB is captured by the digital camera 1B. A main subject SB′ in FIG. 36 expresses, for convenience, the moving main subject SB in a position supposed to be at the time of zoom-in. A main subject SB″ FIG. 37 expresses, for convenience, the moving main subject SB in a position supposed to be at the time of zoom-in in the case where the direction of movement changes halfway. In the moving subject electronic zoom process, different from the stationary subject electronic zoom process, the center CP of the partial area PA is determined on a line L2 connecting an expected position G′ of the main subject SB′ and the center P0 of the image capturing area CA. That is, in the stationary subject electronic zoom process, the center CP of the partial area PA is determined on the basis of the position G itself of the detected main subject SB. In contrast, in the moving subject electronic zoom process, the destination position of the center CP of the partial area PA is determine on the basis of a position G′ to which the detected main subject SB is expected to be moved. FIG. 36 shows, as an example, a state where the center CP of the partial area PA is determined to the expected position G′. In the moving subject electronic zoom process, the center CP of the partial area PA and the size of the partial area PA on the line L2 are determined in accordance with time in which the automatic trimming button 200 is depressed.

Whole Zooming Operation

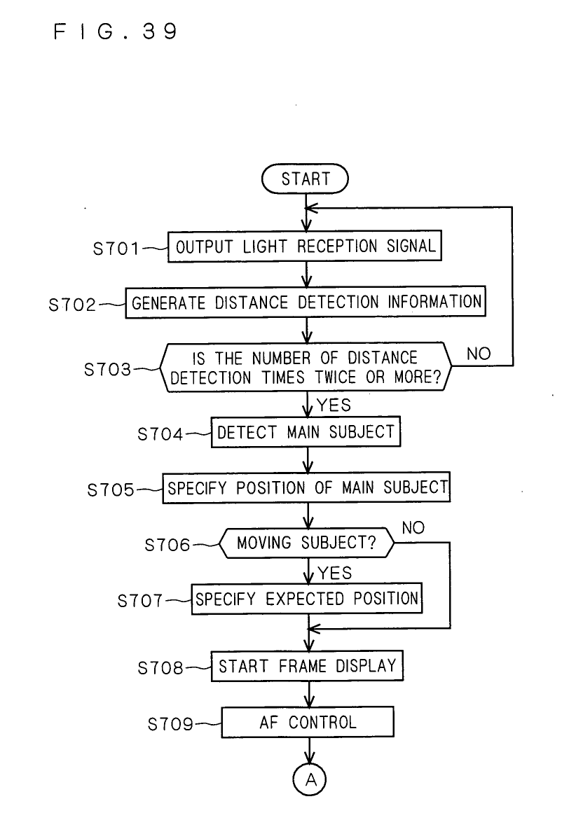

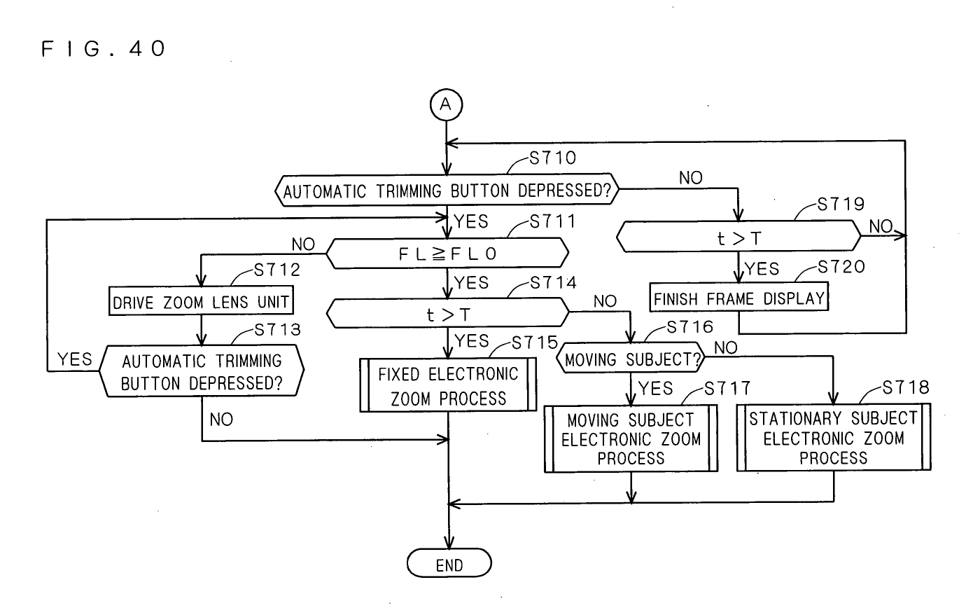

The whole zooming operation of the digital camera 1B will be described with reference to flowcharts of FIGS. 39 and 40.

In the first two steps S701 and S702 of the zooming operation, processes similar to those in steps S501 and S502 (FIG. 26) of the zooming operation of the digital camera 1A are performed. The operation flow moves to step S703.

In the digital camera 1B, the position G′ of the main subject SB at the time point of zoom-in is predicted on the basis of the position G of the main subject SB at two time points, and the center CP of the partial area PA is determined. Consequently, in the digital camera 1B, the distance detection information at the two time points is necessary for the zooming process. In step S703, the zoom processor 255 performs a branched process depending on whether the distance detection information at the two time points is stored in the RAM 252 or not. When the two pieces of distance detection information is not stored (when the number of distance measuring times is one), the operation flow returns to step S701 where distance detection information is generated again. On the other hand, when the two pieces of distance detection information are stored (when the number of distance measuring times is two or more), the operation flow moves to step S704.

In step S704, the main subject position specifying unit 254 specifies the position of the main subject SB by detecting the main subject SB on the distance detection image FI by using the distance detection information supplied from the distance detection CPU 300. After that, the operation flow moves to step S705. In the digital camera 1B, different from the digital camera 1A, the position of the main subject SB at two different past time points is specified.

In step S705, the main subject position specifying unit 254 specifies the position G of the main subject SB in the captured image CI on the basis of the position of the main subject SB in the distance detection image FI. The position G of the main subject SB specified in step S705 is used for determination of whether the main subject SB is moving or stationary, prediction of the position G′ to which the main subject SB is expected to be moved, determination of the position to which the center CP of the partial area PA is expected to be moved in the stationary subject electronic zoom process, and the like.

In step S706, on the basis of the position G of the main subject SB at two time points, whether the main subject SB is a moving subject or not is determined by the zoom processor 255. If the position G of the main subject SB at two time points is in the same block, the zoom processor 255 determines that the main subject SB is a stationary subject. On the other hand, if the positions G of the main subject SB at two time points are in different blocks, the zoom processor 255 determines that the main subject SB is a moving subject. When the main subject SB is determined as a stationary subject, the zoom processor 255 determines the position G of the main subject SB as the position to which the partial area PA moves. After that, the operation flow moves to step S708. On the other hand, when the zoom processor 255 determines that the main subject SB is a moving subject, the operation flow moves to step S707.

In step S707, by using the positions G of the main subject SB at two time points, the expected position G′ of the main subject SB at the time of zoom-in is predicted. To the prediction, various known techniques can be applied. For example, on assumption that the main subject SB maintains the movement speed between the two positions, the expected position G′ at the time of zoom-in can be determined. The zoom processor 255 sets the determined expected position G′ as the position to which the partial area PA moves. After completion of the processes, the operation flow moves to step S708.

Step S708 and subsequent steps of the operation flow are similar to step S505 (FIG. 26) and subsequent steps of the zooming operation of the digital camera 1A. In the digital camera 1B, however, in place of the subroutine (step S515) of the stationary subject electronic zoom process in the digital camera 1A, steps S716 to S718 are executed. In the following, this different point will be described.

In step S716, the zoom processor 255 performs a branching process depending on whether the main subject SB is a moving subject or not. Whether the main subject SB is a moving subject or a stationary subject is determined by a method similar to that in step S706. When the main subject SB is a moving subject, the operation flow moves to step S717. When the main subject SB is not a moving subject, the operation flow moves to step S718.

In steps S717 and S718, the moving subject electronic zoom process and the stationary subject electronic zoom process are executed, respectively. After completion of the steps, the operation flow of the zooming operation of the digital camera 1B is finished.

When depression of the automatic trimming button 200 is canceled and, after that, the automatic trimming button 200 is depressed again, the operations of FIGS. 39 and 40 are performed again.

When depression of the automatic trimming button 200 is canceled or the image magnification k in the fixed electronic zoom process, stationary subject electronic zoom process or moving subject electronic zoom process reaches the upper limit and the zooming operation in FIGS. 39 and 40 is finished and, after that, the down push button DN of the cross switch 205 is operated, the zoom-out operation is performed. In the case where the state at the end of the zooming operation is a state during the optical zoom in steps S510 to S512, the zoom-out is performed by the optical zoom. On the other hand, when the state at the end of the zooming operation is a state during or after the fixed electronic zoom process and stationary subject electronic zoom process of steps S715 and S718, the zoom-out is performed by the electronic zoom by the procedure as described with reference to FIGS. 22 and 25. When the state at the end of the zooming operation is during or after the moving subject electronic zoom process, a zoom-out to be described later is performed. After the image magnification k becomes 1, the zoom-out is performed continuously by the optical zoom.

When the zoom-out reaches the wide angle end, or the depression of the down push button DN of the cross switch 205 is canceled during the zoom-out, the electronic zoom or optical zoom is finished.

By such an operation flow, the zooming process is changed between the stationary subject electronic zoom process and the moving subject electronic zoom process depending on whether the main subject SB is moving or stationary. Thus, the zooming process adapted to the (moving or stationary) state of the main subject SB can be automatically performed.

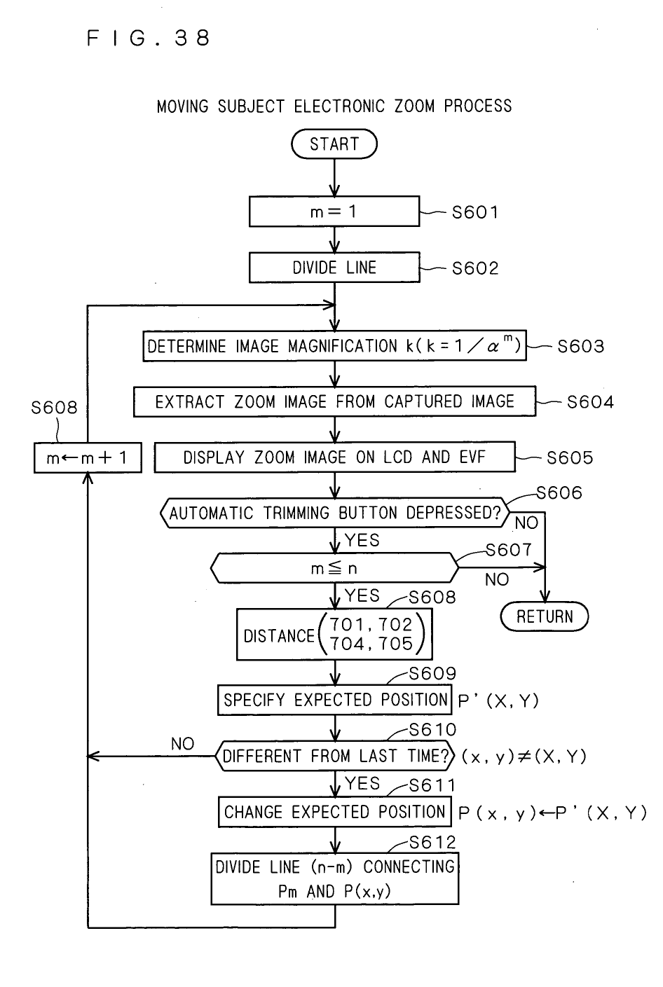

Next, the operation flow of the subroutine of the moving subject electronic zoom process will be described with reference to the flowchart of FIG. 38.

In the first step S601 of the moving subject electronic zoom process, the zoom processor 255 initializes the parameter m used for determining the image magnification k (m=1). The operation flow moves to the next step S602.

In step S602, the zoom processor 255 divides the line L2 connecting the center P0 of the captured image CI and the expected position G′ of the main subject SB into n lines. Although a concrete value of the constant n is not limited, it is assumed here that n=10. In the following, both ends and division points of the line L2 will be expressed as points P0, P1, . . . , and P10 in order from the side close to the center P0 of the captured image CI. After completion of the dividing process, the operation flow shifts to step S603. The expected position G′ of the main subject SB will be described later.

Steps S603 to S608 subsequent to step S602 correspond to steps S403 to S408 (FIG. 25), respectively, in the operation flow of the stationary subject electronic zoom process. In steps S603 to S607, processes similar to those in the corresponding steps S403 to S407 are performed.

In step S608, in a manner similar to steps S701, S702, S704 and S705 in FIG. 36, output of a light reception signal, generation of distance detection information, detection of the main subject, specification of the position of the main subject are performed. From the position of the main subject at the time point closest to the current time point among the positions of the main subject in the past specified in steps S701 to S705 and the latest position of the main subject, the expected position at the current time point is newly specified. In step S610, whether the expected position obtained in step S609 and that obtained in step S707 in FIG. 39 are the same or not is determined. If the result is “same”, it is determined that the movement direction and the moving speed of the main subject SB are unchanged, so that the value of m is incremented in step S608 and the operation flow returns to step S603.

On the other hand, if the newly obtained expected position is different from the expected position obtained in step S707, it is determined that the movement direction or moving speed of the main subject SB has changed. Consequently, the operation flow advances to step S611 where the expected position is changed. That is, the expected position is changed to a new value. After that, the operation flow advances to step S612 where the line connecting the present position Pm of the center CP of the partial area PA and the new expected position G″ divided into (n-m) lines, thereby setting new points Pm+1 to P10. In such a manner, even when the movement direction or moving speed of the main subject SB changes as shown by SB″ FIG. 37, the position of the partial area PA can be changed accordingly.

By such an operation flow, while the automatic trimming button 200 is depressed, the image magnification k gradually increases. Further, in the moving subject electronic zoom process, different from the fixed electronic zoom process, while the automatic trimming button 200 is depressed, the center CP of the partial area PA gradually moves from P0 toward P10. When the depression of the automatic trimming button 200 is interrupted or the center CP of the partial area PA reaches the expected position G′ of the main subject SB, image enlargement by the electronic zoom is stopped. In other words, according to depression time of the automatic trimming button 200, the magnification (size of the partial area PA) and the center CP of the partial area PA synchronously change. By such an operation flow, the main subject SB which does not exist in the center of the captured image CI can be automatically moved to the center of a zoom image. Thus, a framing operation at the time of electronic zooming becomes unnecessary and a camera shake can be prevented. By changing the depression time of the automatic trimming button 200, the degree of zoom-in can be changed. Further, in the moving subject electronic zoom process, zoom-in is carried out by using, as a target position, the expected position determined on the basis of the past position of the main subject SB. Consequently, even when the main subject SB moves, the main subject SB can be captured in the center of a zoom image.

On the other hand, at the time of zoom-out, the down push button DN of the cross switch 205 is depressed. By the depression, the value of m is decremented to 0 and the image magnification k is decreased. At this time, in a manner similar to step S609, the expected position is specified and the center CP of the partial area PA continues moving in association with movement of the center G of gravity of the main subject SB. The operation is continued until one side of the partial area PA reaches an end portion of the image capturing area CA. When the zoom-out is continuously performed after that, the center CP of the partial area PA moves toward the center PO of the image capturing area CA. When the image magnification k reaches 1, the center CP of the partial area PA coincides with the center PO of the image capturing area CA, and the electronic zooming is finished. Also in the case where it is detected that depression of the cross switch 205 is stopped, the electronic zoom is finished.

In the foregoing preferred embodiments, the normal optical zooming is performed by the operation of the up and down push button UP and DN of the cross switch 205 and the flowchart of FIGS. 26, 39 and 40 including the stationary subject electronic zoom process is started by operating the automatic trimming button 200. The other configurations can be also employed. For example, a configuration of switching over a mode by operating any of setup buttons 207 provided for the rear face of the digital camera and executing the flowchart of FIGS. 26, 39 and 40 by operating the up or down push button UP or DN in the cross switch 205 can be also employed. Although the configuration of using the down push button DN of the cross switch 205 even for a normal optical zoom or the flowchart of FIGS. 26, 39 and 40 in order to perform zoom-out is employed in the foregoing preferred embodiments, the configuration of using different members may be also employed.

While the invention has been shown and described in detail, the foregoing description is in all aspects illustrative and not restrictive. It is therefore understood that numerous modifications and variations can be devised without departing from the scope of the invention.

1. An image capturing apparatus comprising:
an optical system for forming a light image of a subject;
an image sensor for converting the light image to image data;
a main object detector for determining the position of a main object in the light image; and
a zoom controller for generating a pseudo zoom image by extracting a partial area in said image, wherein
when a zoom is performed in the direction of increasing an electronic zoom magnification, the zoom controller performs an electronic zoom of increasing the electronic zoom magnification while moving the position of said partial area toward said main object position.

2. The image capturing apparatus according to claim 1, further comprising:
a distance detector for obtaining distance detection information in a two-dimensional distance detection area corresponding to said image, wherein
the main object detector detects the position of the main object on the basis of the obtained distance detection information.

3. The image capturing apparatus according to claim 2, further comprising:
an optical zoom mechanism for changing the size of an image capturing area by changing focal length of said optical system; and
an instruction member for giving an instruction of start of the zoom to the image capturing apparatus, wherein
when the zoom in the direction of increasing the electronic zoom magnification is instructed by said instruction member in a state where the image capturing area is larger than the two-dimensional distance detection area, the optical zoom is started in response to the instruction, and
when the zoom in the direction of increasing the electronic zoom magnification is instructed by said instruction member in a state where the image capturing area is smaller than the two-dimensional distance detection area, the electronic zoom is started in response to the instruction.

4. The image capturing apparatus according to claim 1, further comprising:
an image processor for generating a superimposed image obtained by superimposing information indicative of the position of the main object on said image;
a display capable of displaying said superimposed image; and
an operation member for giving a zoom start instruction to the image capturing apparatus, wherein
the zoom controller can also perform a second electronic zoom of generating a pseudo zoom image by extracting a partial area using a specific fixed position as a center,
when a superimposed image is displayed on the display, in response to the start instruction given by the instruction member, the electronic zoom for moving the position of the partial area is executed, and
when an image on which information indicative of the position of the main object is not superimposed is displayed on the display, in response to the start instruction given by the instruction member, the second electronic zoom is executed.

5. The image capturing apparatus according to claim 4, wherein
display of the superimposed image is continued only for predetermined time and, after lapse of said predetermined time, display of the information indicative of the position of the main object is finished.

6. The image capturing apparatus according to claim 1, further comprising:
an image processor for generating a superimposed image obtained by superimposing information indicative of the position of the main object on said image; and
a display capable of displaying said superimposed image, wherein
the information indicative of the position of the main object is display showing a range of a partial area at a termination end of the operation of increasing the electronic zoom magnification.

7. The image capturing apparatus according to claim 1, wherein
when the main object detector detects a plurality of main objects, the position of the center of gravity of the plurality of main objects is determined as the position of the main objects.

8. The image capturing apparatus according to claim 1, wherein
the size of the partial area at a termination end of the operation of increasing the electronic zoom magnification is determined on the basis of the size of the main object.

9. An image capturing apparatus comprising:
an optical system for forming a light image of a subject;
an image sensor for converting the light image to image data;
a main object detector for determining the position of a main object in the light image; and
a zoom controller for generating a pseudo zoom image by extracting a partial area in said image, wherein
when a zoom is performed in the direction of increasing an electronic zoom magnification, the zoom controller performs an electronic zoom of increasing the electronic zoom magnification while moving the position of the partial area toward a target position determined on the basis of movement of the position of the main subject determined by detection of the position of the main subject at a plurality of time points.

10. The image capturing apparatus according to claim 9, further comprising:
a distance detector for obtaining distance detection information in a two-dimensional distance detection area corresponding to said image, wherein
the main object detector detects the position of the main object on the basis of the obtained distance detection information.

11. The image capturing apparatus according to claim 10, further comprising:
an optical zoom mechanism for changing the size of an image capturing area by changing focal length of said optical system; and
an instruction member for giving an instruction of start of the zoom to the image capturing apparatus, wherein
when a zoom in the direction of increasing the electronic zoom magnification is instructed by said instruction member in a state where the image capturing area is larger than the two-dimensional distance detection area, the optical zoom is started in response to the instruction, and
when a zoom in the direction of increasing the electronic zoom magnification is instructed by said instruction member in a state where the image capturing area is smaller than the two-dimensional distance detection area, the electronic zoom is started in response to the instruction.

12. The image capturing apparatus according to claim 9, further comprising:
an image processor for generating a superimposed image obtained by superimposing information indicative of the position of the main object on said image;
a display capable of displaying said superimposed image; and
an operation member for giving a zoom start instruction to the image capturing apparatus, wherein
the zoom controller can also perform a second electronic zoom of generating a pseudo zoom image by extracting a partial area using a specific fixed position as a center,
when a superimposed image is displayed on the display, in response to the start instruction given by the instruction member, an electronic zoom for moving the position of the partial area is executed, and
when an image on which information indicative of the position of the main object is not superimposed is displayed on the display, in response to the start instruction given by the instruction member, the second electronic zoom is executed.

13. The image capturing apparatus according to claim 12, wherein
display of the superimposed image is continued only for predetermined time and, after lapse of said predetermined time, display of the information indicative of the position of the main object is finished.

14. The image capturing apparatus according to claim 9, further comprising:
an image processor for generating a superimposed image obtained by superimposing information indicative of the position of the main object on said image; and
a display capable of displaying said superimposed image, wherein
the information indicative of the position of the main object is display showing a range of a partial area at a termination end of the operation of increasing the electronic zoom magnification.

15. The image capturing apparatus according to claim 9, wherein
when the main object detector detects a plurality of main objects, the position of the center of gravity of the plurality of main objects is determined as the position of the main objects.

16. The image capturing apparatus according to claim 9, wherein
the size of the partial area at a termination end of the operation of increasing the electronic zoom magnification is determined on the basis of the size of the main object.

17. An image capturing apparatus comprising:
an optical system for forming a light image of a subject;
an image sensor for converting the light image to image data;
a main object detector for determining the position of a main object in the light image;
a zoom controller for generating a pseudo zoom image by extracting a partial area in said image; and
a movement detector for detecting whether the main object is moving or not on the basis of the positions of the main object determined at a plurality of time points, wherein
when a zoom is performed in the direction of increasing an electronic zoom magnification, in a case where the movement detector detects that the main object is not moving, the zoom controller performs an electronic zoom while moving the position of said partial area toward said main object position, and in a case where it is determined that the main object is moving, the zoom controller performs an electronic zoom while moving the position of the partial area toward the target position determined on the basis of the detected movement of the main subject position.

18. The image capturing apparatus according to claim 17, further comprising:
a distance detector for obtaining distance detection information in a two-dimensional distance detection area corresponding to said image, wherein
the main object detector detects the position of the main object on the basis of the obtained distance detection information.

19. The image capturing apparatus according to claim 18, further comprising:
an optical zoom mechanism for changing the size of an image capturing area by changing focal length of said optical system; and
an instruction member for giving an instruction of start of the zoom to the image capturing apparatus, wherein
when a zoom in the direction of increasing the electronic zoom magnification is instructed by said instruction member in a state where the image capturing area is larger than the two-dimensional distance detection area, the optical zoom is started in response to the instruction, and
when a zoom in the direction of increasing the electronic zoom magnification is instructed by said instruction member in a state where the image capturing area is smaller than the two-dimensional distance detection area, the electronic zoom is started in response to the instruction.

20. The image capturing apparatus according to claim 17, wherein
the size of the partial area at a termination end of the operation of increasing the electronic zoom magnification is determined on the basis of the size of the main object.
